(19) United States
(12) Patent Application Publication
(10) Pub. No.: US 2011/0136975 A1
(43) Pub. Date: Jun. 9, 2011

(54) MONOMER MIXTURE, POLYMER, COATING MEANS AND METHOD FOR PRODUCING A COATING

(75) Inventors: Christine Maria Breiner, Laudenbach (DE); Gerold Schmitt, Aschaffenburg (DE); Wolfgang Klesse, Mainz (DE); Mario Gomez Andreu, Pfungstadt (DE)

(73) Assignee: EVONIK ROEHM GMBH, DARMSTADT (DE)

(21) Appl. No.: 13/055,624

(22) PCT Filed: Aug. 31, 2009
(86) PCT No.: PCT/EP2009/061177

§ 371 Date: Jan. 24, 2011

(30) Foreign Application Priority Data
Sep. 8, 2008 (DE) 10 2008 046 076.1
Jun. 8, 2009 (DE) 10 2009 026 819.7

(51) Int. Cl. C08L 29/00; B05D 3/10; C08L 33/02; C08F 26/02; C08F 12/28; C08F 216/34

(52) U.S. Cl. 524/818; 427/385.5; 427/388.1; 427/389; 427/389.9; 427/393; 427/393.5; 525/221; 526/310; 526/312; 526/315

(57) ABSTRACT

The present invention relates to a monomer mixture comprising
at least 30% by weight of one or more alkyl (meth)acrylates having 1 to 10 carbon atoms in the alkyl radical, whose alkyl radical contains no double bonds or heteroatoms, and
0.1% to 40% by weight of one or more (meth)acrylates having at least one aldehyde group in the alkyl radical.

The present invention further relates to polymers obtainable from this monomer mixture and also to coating materials which comprise the stated polymers.

The present invention relates to a monomer mixture and a polymer which is obtainable using this monomer mixture. The present invention is additionally directed to a coating material, to a method of producing a coating and to a coated article.

Coating materials, more particularly paints and varnishes, have for a long time been prepared synthetically. More recent coating materials comprise carbonyl-containing polymers which by addition of crosslinking agents can be cured to relatively solvent-resistant coatings. These coating materials are set out in WO 94/025433 among others. However, improving the profile of properties of these coating materials is an ongoing requirement.

In view of the prior art, then, it is an object of the present invention to provide monomer mixtures which can be processed to polymers having outstanding properties. These properties include more particularly features which become evident through coating materials and coatings which are obtainable from the coating materials.

In particular it ought to be possible to process the monomer mixtures to dispersions or to polymers, emulsion polymers for example, which have a very low residual monomer content.

Additionally, therefore, it was an object of the present invention to provide a coating material which has a particularly long storage life and durability. Furthermore, the intention was that the hardness of the coatings obtainable from the coating materials can be varied over a wide range. The intention was more particularly to be able to obtain mechanically stable coatings which feature high elongation at break and/or a high tensile strength. Furthermore, the coatings obtainable from the coating materials ought to exhibit low brittleness, relative to the hardness and the tensile strength.

A further object is to be seen in providing polymers which can be used to obtain coating materials without volatile organic solvents. The coatings obtainable from the coating materials ought to exhibit high weathering resistance, more particularly a high UV resistance. Furthermore, the films obtainable from the coating materials ought after a short time to feature a low tack.

Moreover, the coatings obtainable from the polymers and monomer mixtures ought to have particularly high resistance towards solvents. In this context this stability ought to be high in respect of a large number of different solvents. There ought also to be very good resistance towards acidic and alkaline cleaning products.

Furthermore, therefore, it was an object of the present invention to specify monomer mixtures, polymers and coating materials which are available at particularly favourable cost. These products, and methods of producing them, ought to be environmentally compatible. With regard to the polymers, they ought to retain equivalent performance for a minimal fraction of monomers that are costly and inconvenient to prepare.

A further object can be seen as being that of providing coating materials for textiles and leather that are especially suited to this end use. More particularly the coatings ought to exhibit high abrasion resistance and a sufficiently high elasticity in conjunction with excellent strength. More particularly the coatings ought to exhibit excellent chemical resistance, particularly in respect of cleaning products, and a low loss on boil washing.

It was an object of the present invention, moreover, to provide coating materials for floor coverings, furniture and other relatively solid substrates that exhibit excellent mechanical load-bearing properties in conjunction with high chemical resistance.

The aim, for example, was to provide binders for industrial coatings and primers that have an outstanding profile of properties. Hence it ought to be possible to use the coating materials in the interior or exterior building sectors, as a masonry paint, for example.

Furthermore, it ought to be possible to apply the coating materials to wood, paper, metal and plastic, particular mention being made of transparent varnishes for wood, industrial varnish for wood and industrial primer for wood. The coating materials ought here to exhibit excellent adhesion, flexibility and corrosion resistance.

These objects and also others which, although not explicitly stated, are nevertheless readily inferable or derivable from the circumstances discussed in the introduction are achieved by a monomer mixture having all of the features of Claim 1. Judicious modifications of the monomer mixtures of the invention are protected in dependent claims. With regard to a polymer, to a coating material, to a method of producing a coating and to a coated article, Claims 16, 20, 21 and 25 provide a solution to the underlying objects.

The present invention accordingly provides a monomer mixture comprising

at least 30% by weight of one or more alkyl (meth)acrylates having 1 to 10 carbon atoms in the alkyl radical, whose alkyl radical contains no double bonds or heteroatoms, and
0.1% to 40% by weight of one or more (meth)acrylates having at least one aldehyde group in the alkyl radical.

Through the measures according to the invention it is additionally possible to obtain advantages including the following:

The monomer mixtures of the invention can be processed to polymers, coating materials and coatings which exhibit a very low residual monomer content.

The hardness of the coatings obtainable from coating materials of the invention, which are based in turn on the polymers or monomer mixtures, can be varied over a wide range. In one preferred modification it is possible more particularly to obtain mechanically stable coatings. The coatings obtainable from the coating materials of the present invention exhibit surprisingly high solvent resistance, which is manifested more particularly in tests with methyl isobutyl ketone (MIRK) or ethanol.

Surprisingly it is possible more particularly to obtain mechanically stable coatings which feature high elongation at break and/or high tensile strength. The coatings obtainable from the coating materials preferably exhibit low brittleness, relative to the hardness and the tensile strength.

Coating materials obtainable using the monomer mixtures of the invention do not generally require any volatile organic solvents. Furthermore, the coating materials of the invention exhibit a high level of storage stability, a high durability and a very good storage life. In particular there is virtually no aggregate formed.

The coatings obtainable from the coating materials of the invention exhibit high weathering stability, more particularly a high UV resistance. Furthermore, the films obtainable from the coating materials after a short time feature a low tack.

The monomer mixtures, polymers and coating materials of the invention can be prepared inexpensively on a large scale. With regard to the polymers, it is possible for them, with no loss of performance, to have a relatively low fraction of monomers which are costly and inconvenient to prepare. The performance of the polymers is evident from, among other parameters, the properties of the coating materials and coatings that are obtainable therefrom.

The coating materials of the invention are eco-friendly and can be prepared and processed safely and without great cost and inconvenience. In this context, the coating materials of the invention exhibit a very high shear stability.

Furthermore, the present coating materials can be used more particularly for the coating of textiles and leather. In particular the coatings obtainable therefrom exhibit high abrasion resistance and a sufficiently high elasticity in conjunction with excellent strength.

Particular embodiments of a coating material of the invention can be used, moreover, on hard substrates, such as wood, metal and plastics, for example, with the resultant coatings having excellent properties. Hence the coatings obtained exhibit an excellent grading in particular in tests in accordance with the DIN 68861-1 furniture test. The mechanical properties, moreover, are excellent. Preferred coatings have in particular a high level of hardness, which can be obtained with low brittleness of the coating. The coatings, furthermore, may exhibit high tensile strength and high elongation at break.

It is additionally possible for binders of the invention to be used for industrial coatings and primers, on account of their outstanding profile of properties. The coating materials can be used, for example, in the interior or exterior buildings sector, as a masonry paint, for example.

The coating materials can be applied, furthermore, to wood, paper, metal and plastic, and are especially suitable as transparent varnishes for wood, industrial varnish for wood and industrial primer for wood. In these contexts the coating materials may exhibit excellent adhesion, flexibility and corrosion resistance.

The monomer mixture of the invention contains 0.1% to 40%, preferably 1% to 20%, more preferably 1.5% to 10% and very preferably 2% to 6% by weight of one or more (meth)acrylates having at least one aldehyde group in the alkyl radical.

(Meth)acrylates having at least one aldehyde group in the alkyl radical correspond in general to the general formula (I)

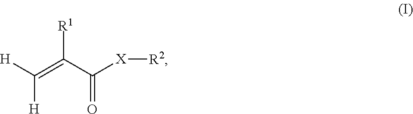

in which R¹ is hydrogen or a methyl group, X is oxygen or a group of the formula NR′ in which R′ is hydrogen or a radical having 1 to 6 carbon atoms, and R² is a radical having 3 to 31 carbon atoms and at least one aldehyde group.

The expression “radical having 1 to 6 carbon atoms” or “radical having 3 to 31 carbon atoms” represents, respectively, a group having 1 to 6 or 3 to 31 carbon atoms. It embraces aromatic and heteroaromatic groups and also alkyl, cycloalkyl, alkoxy, cycloalkoxy, alkenyl, alkanoyl and alkoxycarbonyl groups, and also heteroaliphatic groups. The stated groups may be branched or unbranched. Moreover, these groups may contain substituents, more particularly halogen atoms or hydroxyl groups.

The radicals R′ are preferably alkyl groups. The preferred alkyl groups include the methyl, ethyl, propyl, isopropyl, 1-butyl, 2-butyl, 2-methylpropyl and tert-butyl groups.

In formula (I) the radical R² is a group having 3 to 31 carbon atoms, more particularly having 3 to 25, preferably having 3 to 9, more preferably having 4 to 6 carbon atoms, and comprising at least one aldehyde group. In a further embodiment of the present invention, preference is given to (meth)acrylate monomers which contain 10 to 25, preferably 12 to 24 and very preferably 14 to 23 carbon atoms. In this case the radical R² may comprise one, two, three or more aldehyde groups, it being possible for the radical R² to be substituted and to contain further functional groups, examples being C—C double bonds. In one preferred modification of the present invention the radical R² is an alkyl or alkenyl group which comprises one or two aldehyde groups, preference being given to radicals with just one aldehyde group. This group may comprise heteroatoms, more particularly oxygen atoms and/or nitrogen atoms, in the form, for example, of ester, ether, amino and/or amide group.

In one preferred embodiment the (meth)acrylate having at least one aldehyde group may form an enol or enolate. Accordingly, preferred (meth)acrylates having at least one aldehyde group contain at least one hydrogen atom on the carbon atom in alpha-position to the aldehyde group.

The preferred radicals R² include in particular the 1-formylethyl, 2-formylethyl, 2-formylpropyl, 3-formylpropyl, 2-formyloct-7-enyl, 2,7-diformyloctyl, 9-formyloctadecyl and 10-formyloctadecyl groups.

The preferred (meth)acrylate monomers of formula (I) include, among others, (meth)acrylate monomers having 3 to 9 carbon atoms in the radical R², such as, for example, 3-oxopropyl (meth)acrylate (2-formylethyl (meth)acrylate), 4-oxobutyl (meth)acrylate (3-formylpropyl (meth)acrylate) and 2-methyl-3-oxopropyl (meth)acrylate (2-formyl-2-methylethyl (meth)acrylate), particular preference being given to 4-oxobutyl methyacrylate and 2-methyl-3-oxopropyl methacrylate.

The (meth)acrylate monomers of formula (I) further include (meth)acrylate monomers having 10 to 25 carbon atoms in the radical R², such as (meth)acrylates derived from fatty acids, fatty alcohols and fatty acid amides, such as 9-formyloctadecan-12-enyl (meth)acrylate, 9,12-diformyloctadecyl (meth)acrylate, 12-formyloctadecan-6,9-dienyl (meth)acrylate, 9-formylhexadecyl (meth)acrylate, 10-formylhexadecyl (meth)acrylate, 9-formyloctadecyl (meth)acrylate, 10-formyloctadecyl (meth)acrylate, (meth)acryloyloxy-2-hydroxypropyl-9-formyloctadecanoic ester, (meth)acryloyloxy-2-hydroxypropyl-10-formyloctadecanoic ester, (meth)acryloyloxy-2-hydroxypropyl-9-formylocta-decanamide and/or (meth)acryloyloxy-2-hydroxypropyl-10-formyloctadecanamide.

The stated monomers can be used individually or as a mixture of two or more compounds.

(Meth)acrylate monomers of formula (I) can be obtained, with advantages unforeseeable for a person skilled in the art, by reaction of a reactant of the formula (II)

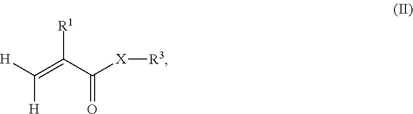

in which R¹ is hydrogen or a methyl group, X is oxygen or a group of the formula NR′ in which R′ is hydrogen or a radical having 1 to 6 carbon atoms, and R³ is an unsaturated radical having at least one C—C double bond and 2 to 30 carbon atoms, preferably 2 to 24 carbon atoms, with carbon monoxide and hydrogen in the presence of a catalyst.

Particular advantages in respect of a surprisingly high selectivity can be achieved through the use of methacrylates, and so methacrylates are preferred over the acrylates. The selectivity relates to the different reactions of the double bonds that are present in the compounds of formula (II), it being the case, surprisingly, that it is substantially the double bonds present in radical R³ that are reacted, without a reaction of the double bond of the (meth)acrylic group.

Reactions of unsaturated compounds with carbon monoxide and hydrogen in the presence of a catalyst are frequently referred to as hydroformylation processes. As the catalyst it is possible more particularly to use metals and/or metallic compounds, preferred metals being those belonging to the iron-platinum group comprising iron, cobalt, nickel, ruthenium, rhodium, palladium, osmium, iridium and platinum. The preferred catalysts include more particularly compounds which comprise rhodium, iridium, palladium and/or cobalt, with rhodium being particularly preferred. Cobalt is particularly preferred as well.

These metals can preferably be used more particularly in the form of complexes, with the central atom being bonded via elements of group V. These include, in particular, complexes with ligands which contain nitrogen, phosphorus, antimony and/or arsenic.

In one particular embodiment it is possible more particularly to use complexes comprising at least one phosphorus compound as ligand for the catalysis. Preferred phosphorus compounds comprise aromatic groups and at least one, more preferably two, phosphorus atom(s). The phosphorus compounds include more particularly phosphines, phosphites, phosphinites and phosphonites. Examples of phosphines are triphenylphosphine, tris(p-tolyl)phosphine, tris(m-tolyl)phosphine, tris(o-tolyl)phosphine, tris(p-methoxyphenyl)phosphine, tris(p-dimethylaminophenyl)phosphine, tricyclohexylphosphine, tricyclopentylphosphine, triethylphosphine, tri(1-naphthyl)phosphine, tribenzylphosphine, tri-n-butylphosphine and tri-tert-butylphosphine. Examples of phosphites are trimethyl phosphite, triethyl phosphite, tri-n-propyl phosphite, triisopropyl phosphite, tri-n-butyl phosphite, triisobutyl phosphite, tri-tert-butyl phosphite, tris(2-ethylhexyl)phosphite, triphenyl phosphite, tris(2,4-di-tert-butylphenyl)phosphite, tris(2-tert-butyl-4-methoxyphenyl)phosphite, tris(2-tert-butyl-4-methylphenyl)phosphite and tris(p-cresyl)phosphite. Examples of phosphonites are methyldiethoxyphosphine, phenyldimethoxyphosphine, phenyldiphenoxyphosphine, 2-phenoxy-2H-dibenz[c,e][1,2]oxaphosphorine and its derivatives in which some or all of the hydrogen atoms have been replaced by alkyl and/or aryl radicals or by halogen atoms. Common phosphinite ligands are diphenyl-(phenoxy)phosphine and its derivatives diphenyl(methoxy)phosphine and diphenyl(ethoxy)-phosphine.

Surprising advantages can be obtained more particularly with chelating ligands, particular preference being given to ligands having a high volume, more particularly two or more aromatic or cyclic groups.

The particularly preferred ligands include more particularly 4,5-bis(diphenylphosphino)-9,9-dimethyl-xanthene (xantphos) and its derivative 10,10′-(2,7-di-tert-butyl-9,9-dimethyl-9H-xanthene-4,5-diyl)bis(10H-phenoxaphosphinine) (POP-xantphos) and biphephos

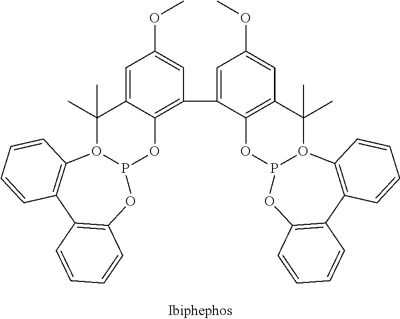

Catalysts and ligands for hydroformylation are disclosed, for example, in WO 2008/071508 A1, filed on 13 Nov. 2007 at the European Patent Office with the application number PCT/EP2007/062248; EP 982 314 B1, filed on 17 Aug. 1999 at the European Patent Office with the application number 99116208; WO 2008/012128 A1, filed on 29 May 2007 at the European Patent Office with the application number PCT/EP2007/055165; WO 2008/006633 A1, filed on 11 May 2007 at the European Patent Office with the application number PCT/EP2007/054576; WO 2007/036424 A1, filed on 8 Sep. 2006 at the European Patent Office with the application number PCT/EP2006/066181; WO 2007/028660 A1, filed on 2 Jun. 2006 at the European Patent Office with the application number PCT/EP2006/062872; WO 2005/090276 A1, filed on 27 Jan. 2005 at the European Patent Office with the application number PCT/EP2005/050347, reference being made to these publications for disclosure purposes, and the catalysts and ligands disclosed therein being incorporated into the present specification.

In one particular embodiment of the present method it is possible for the phosphorus compound employed as ligand to be used in excess relative to the metal. By means of this embodiment it is possible to obtain surprising advantages with respect to selectivity and reactivity. The ratio of metal to ligand can be situated preferably in the range from 1:1 to 1:1000, more preferably in the range from 1:2 to 1:200.

The preferred starting materials that can be used to prepare the (meth)acrylates of formula (I) and conform to formula (II) above include, among others, (meth)acrylates having 2 to 8 carbon atoms in the alkyl radical and deriving from unsaturated alcohols, and (meth)acrylates having 9 to 30, preferably 9 to 24, carbon atoms in the alkyl radical and containing at least one carbon-carbon double bond.

The (meth)acrylates having 2 to 8 carbon atoms in the alkyl radical and deriving from unsaturated alcohols include 2-propynyl (meth)acrylate, allyl (meth)acrylate and vinyl (meth)acrylate.

The (meth)acrylates having 9 to 30 carbon atoms, preferably 9 to 24 carbon atoms, in the alkyl radical, with at least one double bond in the alkyl radical, include more particularly (meth)acrylates deriving from unsaturated fatty acids, fatty alcohols and fatty acid amides, such as heptadecenyloyloxy-2-ethyl-(meth) acrylamide, heptadecan-dien-yloyloxy-2-ethyl-(meth) acrylamide, heptadecan-trien-yloyloxy-2-ethyl-(meth) acrylamide, (meth) acryloyloxy-2-ethyl-palmitolamide, (meth) acryloyloxy-2-ethyl-oleamide, (meth) acryloyloxy-2-ethyl-eicosenamide, (meth) acryloyloxy-2-ethyl-cetoleamide, (meth)acryloyloxy-2-ethyl-erucamide, (meth)acryloyloxy-2-ethyl-linoleamide, (meth)acryloyloxy-2-ethyl-linolenamide, (meth)acryloyloxy-2-propyl-palmitolamide, (meth) acryloyloxy-2-propyl-oleamide, (meth) acryloyloxy-2-propyl-eicosenamide, (meth) acryloyloxy-2-propyl-cetoleamide, (meth)acryloyloxy-2-propyl-erucamide, (meth)acryloyloxy-2-propyl-linoleamide and (meth)acryl-oyloxy-2-propyl-linolenamide; (meth) acryloyloxy-2-hydroxypropyl-linoleic ester, (meth)acryloyloxy-2-hydroxypropyl-linolenic ester and (meth)acryloyloxy-2-hydroxypropyl-oleic ester; octadecan-dien-yl (meth)acrylate, octadecan-trien-yl (meth)acrylate, hexadecenyl (meth)acrylate, octadecenyl (meth)acrylate and hexadecan-dien-yl (meth)acrylate.

The reactants of formula (II) can be used individually or as a mixture.

In addition to the reactant or reactants of formula (II) and the above-described catalysts, hydrogen (H₂) and carbon monoxide (CO) are used for the reaction. Preferably the reaction can be carried out with an overall gas pressure in the range from 1 to 200 bar, more preferably in the range from 1 to 150 bar, with particular preference in the range from 1 to 100 bar. In accordance with a further aspect of the present invention the overall gas pressure is preferably 2 to 30 bar, more preferably 3 to 20 bar. Surprisingly it is possible to enhance the selectivity and the yield of carbonyl compound of formula (I) at relatively low pressure levels.

In accordance with one particular aspect of the present invention, the hydrogen pressure at which the reaction is carried out can be greater than the pressure of carbon monoxide. The molar ratio of hydrogen to carbon monoxide may be situated more particularly in the range from 10:1 to 1:10, more preferably in the range from 1:1 to 2:1.

The temperature at which the reaction of the reactant of formula (II) with hydrogen and carbon monoxide is carried out is not critical per se. Particular advantages can be achieved more particularly by carrying out the reaction at a temperature in the range from 20 to 250° C., preferably from 40 to 200° C., more preferably in the range from 50 to 160° C. In accordance with a further modification of the present invention, the temperature may be situated in the range from 30 to 100° C., more preferably 40 to 80° C. and very preferably 50 to 65° C.

Surprisingly it is possible to enhance the selectivity and the yield of carbonyl compound of formula (I) at relatively low temperature levels.

The reaction time is dependent in particular on the catalyst system used and on the reaction regime, and accordingly may lie within a relatively wide range. Preferably the reaction time or residence time (in the case of continuous methods) is situated in the range from 1 minute to 30 hours, more preferably 10 minutes to 20 hours.

In accordance with one particular aspect of the present invention, the reaction may be carried out in an inert organic solvent. These solvents include, for example, aromatic hydrocarbons, such as toluene or xylene, ethers, such as THF or dioxane, and carboxylic esters, such as ethyl acetate, for example. With particular advantage the reaction can be carried out substantially without the use of an inert organic solvent. In this case more particularly the reactants and also the ligands form the medium in which the reaction is performed.

The weight fraction of metallic catalyst in the reaction mixture for preparing a carbonyl compound according to Claim 1 is situated preferably in the range from 1 to 1000 ppm, more preferably in the range from 2 to 500 ppm and very preferably in the range from 5 ppm to 300 ppm, based on the total weight of the reaction mixture. The fraction of metallic catalyst here refers to the weight of the metal present in the catalyst.

Surprising advantages can be achieved, moreover, through the use of a stabilizer. Preferred stabilizers, such as, for example, hydroquinones, hydroquinone ethers, such as hydroquinone monomethyl ether or di-tert-butylpyrrocatechol, phenothiazine, methylene blue or sterically hindered phenols, an example being 2,4-dimethyl-6-tert-butylphenol, are widely known within the art. These compounds can be used individually or in the form of mixtures and are generally available commercially. For further details refer to the current technical literature, and especially to Römpp-Lexikon Chemie; editors: J. Falbe, M. Regitz; Stuttgart, New York; 10^{th} edition (1996); entry heading “Antioxidantien” [Antioxidants] and the references cited in that entry.

The hydroformylation can be carried out continuously or discontinuously. Examples of technical configurations are stirred tanks, bubble columns, jet nozzle reactors, tube reactors or loop reactors, which in some cases can be cascaded and/or fitted with internals.

The reaction may take place straight or in two or more stages. The aldehyde compounds formed and the catalyst may be separated by a conventional technique, such as fractionation, extraction, nanofiltration with corresponding membranes. Technically this may take place, for example, via a distillation, via a falling film evaporator or a thin-film evaporator. This is the case especially when the catalyst in solution in a high-boiling solvent is separated off from the lower-boiling products. The catalyst solution that is separated off may be used for further hydroformylations.

Advantages not obvious per se to the person skilled in the art may be achieved by means of a monomer mixture which contains 1% to 8% by weight, more preferably 2% to 6% by weight, of (meth)acrylates having at least one aldehyde group in the alkyl radical, based on the total weight of the monomers.

Besides at least one (meth)acrylate having at least one aldehyde group in the alkyl radical, a monomer mixture of the invention comprises at least 30%, preferably at least 55% and very preferably at least 70% by weight of one or more alkyl (meth)acrylates having 1 to 10 carbon atoms in the alkyl radical, whose alkyl radical contains no double bonds or heteroatoms. The expression (meth)acrylates encompasses methacrylates and acrylates and also mixtures thereof. These monomers are widely known.

They include more particularly alkyl (meth)acrylates which derive from linear or branched saturated alcohols, such as, for example, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, pentyl (meth)acrylate, hexyl (meth)acrylate, 2-ethylhexyl (meth)acrylate, heptyl (meth)acrylate, octyl (meth)acrylate, 3-isopropylheptyl (meth)acrylate, nonyl (meth)acrylate, decyl (meth)acrylate; and cycloalkyl (meth)acrylates, such as cyclopentyl (meth)acrylate, cyclohexyl (meth)acrylate, cyclohexyl (meth)acrylates having at least one substituent on the ring, such as tert-butylcyclohexyl (meth)acrylate and trimethylcyclo-hexyl (meth)acrylate, norbornyl (meth)acrylate, methylnorbornyl (meth)acrylate, dimethylnorbornyl (meth)acrylate, bornyl (meth)acrylate, 1-adamantyl (meth)acrylate, 2-adamantyl (meth)acrylate, menthyl (meth)acrylate and isobornyl (meth)acrylate.

In one particular embodiment, monomer mixtures of interest in particular are those which comprise alkyl acrylates having 1 to 10 carbon atoms in the alkyl radical, whose alkyl radical contains no double bonds or heteroatoms.

These include more particularly alkyl acrylates deriving from saturated alcohols, such as, for example, methyl acrylate, ethyl acrylate, n-propyl acrylate, isopropyl acrylate, n-butyl acrylate, tert-butyl acrylate, pentyl acrylate, hexyl acrylate, heptyl acrylate, octyl acrylate and ethylhexyl acrylate; and cycloalkyl acrylates, such as cyclopentyl acrylate and cyclohexyl acrylate. Of the stated alkyl acrylates, ethyl acrylate, butyl acrylate and ethylhexyl acrylate are particularly preferred, and butyl acrylate is very particularly preferred.

Particularly preferred monomer mixtures in accordance with the first aspect of the present invention may contain at least 30%, preferably at least 55% and very preferably at least 70% by weight of one or more alkyl acrylates having 1 to 10 carbon atoms in the alkyl radical, whose alkyl radical contains no double bonds or heteroatoms.

In accordance with one particular embodiment of the present invention, preferred monomer mixtures are more particularly those which comprise methacrylates having 1 to 10 carbon atoms in the alkyl radical, whose alkyl radical contains no double bonds or heteroatoms.

These include more particularly alkyl methacrylates having 1 to 10 carbon atoms in the alkyl radical and deriving from saturated alcohols, such as methyl methacrylate, ethyl methacrylate, n-propyl methacrylate, isopropyl methacrylate, n-butyl methacrylate, tert-butyl methacrylate and pentyl methacrylate, hexyl methacrylate, 2-ethylhexyl methacrylate, heptyl methacrylate, octyl methacrylate, 3-isopropylheptyl methacrylate, nonyl methacrylate, decyl methacrylate, and cycloalkyl methacrylates, such as cyclopentyl methacrylate, cyclohexyl methacrylate and isobornyl methacrylate. In this context methyl methacrylate and cycloalkyl methacrylates are particularly preferred.

Preferably a monomer mixture in accordance with the first embodiment may comprise 0% to 60%, preferably 10% to 50% and very preferably 20% to 40% by weight of alkyl methacrylates having 1 to 10 carbon atoms in the alkyl radical, whose alkyl radical contains no double bonds or heteroatoms.

Surprising advantages can be achieved in particular by means of monomer mixtures in accordance with the first embodiment that feature a relatively high weight ratio of alkyl acrylates having 1 to 10 carbon atoms in the alkyl radical to the alkyl methacrylates having 1 to 10 carbon atoms in the alkyl radical. Preferably the weight ratio of alkyl acrylate having 1 to 10 carbon atoms in the alkyl radical to alkyl methacrylate having to 10 carbon atoms in the alkyl radical may be situated in the range from 1:1 to 50:1, more preferably 3:2 to 5:1.

Monomer mixtures in accordance with the first embodiment are especially suitable for preparing polymers and coating materials which find application on very flexible materials, especially woven fabrics, knitted fabrics and nonwoven fabrics. Accordingly these coating materials may be employed more particularly on textiles, leather and/or web material such as fibre webs or nonwovens. In this context the materials to be coated are not subject to any particular restriction, and so the coating materials may be employed on natural fibres, man-made fibres and/or glass fibres, more particularly on glass fibre webs.

Particularly preferred monomer mixtures in accordance with a second aspect of the present invention may contain at least 30% by weight, preferably at least 55% by weight and most preferably at least 70% by weight of one or more alkyl methacrylates having 1 to 10 carbon atoms in the alkyl radical, whose alkyl radical contains no double bonds or heteroatoms.

Preferably a monomer mixture in accordance with the second embodiment may comprise 0% to 60%, preferably 10% to 50% and very preferably 20% to 40% by weight of alkyl acrylates having 1 to 10 carbon atoms in the alkyl radical, whose alkyl radical contains no double bonds or heteroatoms.

Surprising advantages may be achieved more particularly by monomer mixtures in accordance with the second embodiment that are distinguished by a relatively low weight ratio of alkyl acrylates having 1 to 10 carbon atoms in the alkyl radical to alkyl methacrylates having 1 to 10 carbon atoms in the alkyl radical. Preferably the weight ratio of acrylate having 1 to 10 carbon atoms in the alkyl radical to alkyl methacrylate having 1 to 10 carbon atoms in the alkyl radical may be situated in the range from 1:50 to 1:1, more preferably 1:5 to 2:3.

Monomer mixtures in accordance with the second embodiment are suitable more particularly for producing polymers and coating materials that are suitable for relatively solid materials, more particularly for wood, metals and plastics.

Besides the monomers set out above, a monomer mixture of the invention may comprise further monomers which are copolymerizable with the further monomers. These copolymerizable monomers include, among others, monomers containing an acid group, monomers A comprising ester groups and differing from the (meth)acrylates set out above having at least one aldehyde group in the alkyl radical and from alkyl (meth)acrylates having 1 to 10 carbon atoms in the alkyl radical, monomers having an amino group or amide group, and styrenic monomers.

One preferred group of comonomers is that of monomers having an amino or amide group.

These monomers include more particularly monomers having a primary amide group (—CO—NH₂) or a secondary amide group (—CO—NHR), such as, for example, (meth) acrylamide, N-methylolmethacrylamide, N,N-dimethylaminopropyl(meth)acrylamide, diacetoneacrylamide, with methacrylamide being especially preferred. They further include monomers derived from fatty acid amides, such as, for example, (meth)acrylates which derive from saturated fatty acid amides, such as pentadecyloyloxy-2-ethyl-(meth)acryl-amide, heptadecyloyloxy-2-ethyl-(meth)acrylamide, (meth)acryloyloxy-2-ethyl-lauramide, (meth)acryloyloxy-2-ethyl-myristamide, (meth) acryloyloxy-2-ethyl-palmitamide, (meth) acryloyloxy-2-ethyl-stearamide, (meth) acryloyloxy-2-propyl-lauramide, (meth)acryloyl-oxy-2-propyl-myristamide, (meth) acryloyloxy-2-propyl-palmitamide and (meth) acryloyloxy-2-propyl-stearamide, and (meth)acrylates which derive from unsaturated fatty acid amides, such as heptadecenyloyloxy-2-ethyl-(meth) acrylamide, heptadecan-dien-yloyloxy-2-ethyl-(meth) acrylamide, heptadecan-trien-yloyloxy-2-ethyl-(meth)acrylamide, heptadecenyloyloxy-2-ethyl-(meth) acrylamide, (meth) acryloyloxy-2-ethyl-palmitol-amide, (meth)acryloyloxy-2-ethyl-oleamide, (meth)-acryloyloxy-2-ethyl-eicosenamide, (meth) acryloyloxy-2-ethyl-cetoleamide, (meth)acryloyloxy-2-ethyl-erucamide, (meth)acryloyloxy-2-ethyl-linoleamide, (meth)acryloyl-oxy-2-ethyl-linolenamide, (meth)acryloyloxy-2-propyl-palmitolamide, (meth) acryloyloxy-2-propyl-oleamide, (meth)acryloyloxy-2-propyl-eicosenamide, (meth)-acryloyloxy-2-propyl-cetoleamide, (meth) acryloyloxy-2-propyl-erucamide, (meth) acryloyloxy-2-propyl-linoleamide and (meth)acryloyloxy-2-propyl-linolenamide.

Of these, more particular preference is given to monomers having a primary amide group. Preference extends to monomers having an amide group that contain up to 20 carbon atoms, preferably up to 15 carbon atoms and more preferably up to 10 carbon atoms.

Additionally included among these monomers are monomers having a primary amino group, such as, for example, aminoethyl (meth)acrylate, aminopropyl (meth)acrylate, aminopentyl (meth)acrylate and aminohexadecyl (meth)acrylate; a secondary amino group, such as, for example, N-methylaminoethyl (meth)acrylate, N-methylaminopropyl (meth)acrylate, N-ethylaminopentyl (meth)acrylate and N-butylaminohexadecyl (meth)-acrylate; or a tertiary amino group, such as, for example, N,N-dimethylaminoethyl (meth)acrylate, N,N-dimethylaminopropyl (meth)acrylate, N,N-diethylamino-pentyl (meth)acrylate and N,N-dibutylaminohexadecyl (meth)acrylate.

In accordance with one preferred embodiment, monomers having a primary amide group (—CO—NH₂) or a secondary amide group (—CO—NHR) are more particularly preferred. Coatings obtained from coating compositions with polymers which comprise amide groups exhibit good mechanical properties and high solvent resistance, and these coating compositions exhibit outstanding durability.

In accordance with a further aspect, monomers having an amino group are preferred. Coatings obtainable from coating materials with polymers which comprise amino groups exhibit outstanding performance properties, these performance properties including more particularly good mechanical properties and excellent resistance to various solvents. These performance properties are achieved at comparatively low heat-treatment temperatures and in relatively short heat-treatment times. In this context it is possible more particularly for monomers having a secondary amino group to lead to particular performance properties, especially with respect to the mechanical properties and the solvent resistance. Monomers having a primary or tertiary amino group are distinguished by a relatively balanced ratio between durability of the coating material and performance properties of the coating.

In accordance with one particular aspect of the present invention a monomer mixture may contain 0.1% to 10% by weight, more preferably 0.5% to 5% by weight, of monomer with an amino group or amide group, based on the total weight of the monomers.

In the case of monomer mixtures for preparing coating materials that are particularly suitable for flexible materials, such as textiles, it is possible, by using monomers having an amino group or amide group, to obtain surprising advantages in respect of chemical resistance, more particularly with respect to swelling in MIBK.

In the case of application on relatively solid substrates, especially wood or metals, polymers and coating materials derived from monomers having an amino group or amide group exhibit surprising advantages in respect of mechanical properties, more particularly of tensile strength.

Surprising advantages can be achieved in particular by means of monomer mixtures which comprise polyalkylene glycol mono(meth)acrylates. Thus polymers, more particularly polymer dispersions, which are obtainable from these monomer mixtures exhibit outstanding processing properties, more particularly an excellent shear stability.

Polyalkylene glycol mono(meth)acrylates are monomers which in addition to a (meth)acrylate group contain a polyalkylene glycol radical. The preparation of these monomers is set out in references including WO 2006/024538, filed on 2 Sep. 2005 at the European Patent Office with the application number PCT/EP2005/009466, and WO 2005/000929, filed on 20 May 2004 at the American Patent Office (USPTO) with the application number PCT/US2004/015898, these publications being referred to for purposes of disclosure, and the polyalkylene glycol mono(meth)acrylates and processes for preparing them that are described therein being incorporated into the present specification. For instance, polyalkylene glycol mono(meth)acrylates having a hydroxyl group may be obtained by reacting (meth)acrylic acid with epoxides. Additionally, polyalkylene glycol mono(meth)acrylates may be obtained by transesterifying alkyl (meth)acrylates with alkoxy polyalkylene glycols, more particularly methoxypolyalkylene glycols.

The weight-average molecular weight of the polyalkylene glycol mono(meth)acrylate is situated preferably in the range from 350 to 20 000 g/mol, more preferably in the 500 to 10 000 g/mol range, as measured by GPC.

The preferred polyalkylene glycols for preparing the polyalkylene glycol mono(meth)acrylates include more particularly poly-C₂-C₄ alkylene glycol compounds. Poly-C₂-C₄ alkylene glycol compounds, also referred to occasionally as poly-C₂-C₄ alkylene oxides or poly(oxy-C₂ C₄ alkylene) compounds, are oligomeric or macromolecular polyethers having two or more, generally at least 3, frequently at least 5 and in particular at least 10, and generally not more than 500, frequently not more than 400, for example 7 to 300 and more particularly 10 to 200, repeating units derived from C₂-C₄ alkylene glycols. These compounds may be linear or branched.

Preferred polyalkylene glycol mono(meth)acrylates may be described by the general formula (III):

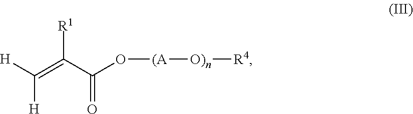

in which n indicates the number of repeating units and is in general a number in the range from 3 to 500, more particularly in the range from 5 to 400, more preferably in the range from 10 to 300 and very preferably in the range from 10 to 200, A is C₂-C₄ alkylene such as 1,2-ethanediyl, 1,3-propanediyl, 1,2-propanediyl, 1,2-butanediyl or 1,4-butanediyl; R¹ is hydrogen or methyl and R⁴ is hydrogen or alkyl having preferably 1 to 10 and more particularly 1 to 4 C atoms, phenyl, benzyl, acyl (═C(O)-alkyl) having preferably 1 to 10 C atoms, SO₃H groups or PO₃H₂, more particularly C₁-C₁₀ alkyl and with particular preference C₁-C₄ alkyl, and especially methyl or ethyl.

A feature of (poly-C₂-C₄ alkylene glycol)-mono(meth)acrylic esters which can be used with particular preference is that at least 50% by weight, preferably at least 70% by weight, more particularly at least 90% by weight, and especially all, of the repeating units A-O in formula (III) are derived from ethylene glycol or from ethylene oxide. Accordingly, preferably at least 50% by weight, more particularly at least 70% by weight, very preferably at least 90% by weight, and especially all of the units A-O in formula (III) are CH₂—CH₂—O. In accordance with a further preferred embodiment of the present invention it is possible for at least 50% by weight, preferably at least 70% by weight, more particularly at least 90% by weight and especially all of the repeating units A-O in formula (III) to be derived from propylene glycol or propylene oxide.

The preferred polyalkylene glycol mono(meth)acrylates include more particularly alkoxypolyalkylene glycol mono(meth)acrylates which are notable for an alkyl group as radical R⁴ in formula (III) above. Particular preference in this context is given more particularly to methoxypolyethylene glycol mono(meth)acrylates, also referred to as MPEG (meth)acrylates.

Polyalkylene glycol mono(meth)acrylates which can be used with particular preference are methoxypolyethylene glycol monomethacrylates with the CAS No. 26915-72-0. These methoxypolyethylene glycol monomethacrylates preferably have a number-average molecular weight in the range from 350 to 5500, and so n in formula (III) above is situated preferably in the range from 6 to 120. These monomers may be obtained commercially in particular under the trade names Plex® 6850-0, Plex® 6969-0, Plex® 6968-0 and Plex® 6965-0 from Evonik Röhm GmbH.

Surprising advantages can be obtained in particular by monomer mixtures which contain 0.1% to 10%, more preferably 1% to 5% and very preferably 2% to 3% by weight of polyalkylene glycol mono(meth)acrylates, based on the weight of the monomers in the monomer mixture.

Monomers containing acid groups are compounds which can be copolymerized preferably free-radically with the monomers set out above. They include, for example, monomers with a sulphonic acid group, such as vinylsulphonic acid, for example; monomers with a phosphonic acid group, such as vinylphosphonic acid, for example; and unsaturated carboxylic acids, such as methacrylic acid, acrylic acid, itaconic acid, fumaric acid and maleic acid, for example. Methacrylic acid and acrylic acid are particularly preferred. The monomers containing acid groups may be used individually or as a mixture of two, three or more monomers containing acid groups.

In accordance with one preferred embodiment of the present invention a monomer mixture may contain 0.1% to 10% by weight, more preferably 0.5% to 5% by weight, of monomers containing acid groups, based on the total weight of the monomers.

The preferred monomers A comprising ester groups include more particularly (meth)acrylates which differ from the monomers of formula (I) and from the alkyl (meth)acrylates having 1 to 10 carbon atoms in the alkyl radical, fumarates, maleates and/or vinyl acetate.

They include, for example, (meth)acrylates having at least 11 carbon atoms in the alkyl radical and deriving from saturated alcohols, such as, for example, 2-tert-butylheptyl (meth)acrylate, undecyl (meth)acrylate, 5-methylundecyl (meth)acrylate, dodecyl (meth)acrylate, 2-methyldodecyl (meth)acrylate, tridecyl (meth)-acrylate, 5-methyltridecyl (meth)acrylate, tetradecyl (meth)acrylate, pentadecyl (meth)acrylate, hexadecyl (meth)acrylate, 2-methylhexadecyl (meth)acrylate, heptadecyl (meth)acrylate, 5-isopropylheptadecyl (meth)acrylate, 4-tert-butyloctadecyl (meth)acrylate, 5-ethyloctadecyl (meth)acrylate, 3-isopropyloctadecyl (meth)acrylate, octadecyl (meth)acrylate, nonadecyl (meth)acrylate, eicosyl (meth)acrylate, cetyleicosyl (meth)acrylate, stearyleicosyl (meth)acrylate, docosyl (meth)acrylate and/or eicosyltetratriacontyl (meth)acrylate;

cycloalkyl (meth)acrylates, such as 3-vinylcyclohexyl (meth)acrylate, 2,4,5-tri-tert-butyl-3-vinylcyclohexyl (meth)acrylate and 2,3,4,5-tetra-tert-butylcyclohexyl (meth)acrylate;
heterocyclic (meth)acrylates, such as 2-(1-imidazolyl)ethyl (meth)acrylate, 2-(4-morpholinyl)ethyl (meth)acrylate, 1-(2-methacryloyloxyethyl)-2-pyrroli-done and 2-(3-oxazolidinyl)ethyl methacrylate;
nitriles of (meth)acrylic acid and other nitrogen-containing methacrylates, such as N-(methacryloyl-oxyethyl)diisobutylketimine, N-(methacryloyloxyethyl)-dihexadecylketimine, methacryloylamidoacetonitrile, 2-methacryloyloxyethylmethylcyanamide and cyanomethyl methacrylate;
aryl (meth)acrylates, such as benzyl (meth)acrylate or phenyl (meth)acrylate, it being possible for the aryl radicals in each case to be unsubstituted or to be substituted up to four times;
(meth)acrylates having a hydroxyl group in the alkyl radical, more particularly 2-hydroxyethyl (meth)acrylate, preferably 2-hydroxyethyl methacrylate (HEMA), hydroxypropyl (meth)acrylate, for example 2-hydroxypropyl (meth)acrylate and 3-hydroxypropyl (meth)acrylate, preferably hydroxypropyl methacrylate (HPMA), hydroxybutyl (meth)acrylate, preferably hydroxybutyl methacrylate (HEMA), 3,4-dihydroxybutyl (meth)acrylate, 2,5-dimethyl-1,6-hexanediol (meth)-acrylate, 1,10-decanediol (meth)acrylate, glycerol mono(meth)acrylate and polyalkoxylated derivatives of (meth)acrylic acid, more particularly polypropylene glycol mono(meth)acrylate having 2 to 10, preferably 3 to 6, propylene oxide units, preferably polypropylene glycol monomethacrylate having about 5 propylene oxide units (PPM5), polyethylene glycol mono(meth)acrylate having 2 to 10, preferably 3 to 6, ethylene oxide units, preferably polyethylene glycol monomethacrylate having about 5 ethylene oxide units (PEM5), polybutylene glycol mono(meth)acrylate and polyethylene glycol-polypropylene glycol mono(meth)acrylate;
(meth)acrylates having two or more (meth)acrylic groups, glycol di(meth)acrylates, such as ethylene glycol di(meth)acrylate, diethylene glycol di(meth)acrylate, triethylene glycol di(meth)acrylate, tetra- and polyethylene glycol di(meth)acrylate, 1,3-butanediol (meth)acrylate, 1,4-butanediol (meth)-acrylate, 1,6-hexanediol di(meth)acrylate and glycerol di(meth)acrylate;
dimethacrylates of ethoxylated bisphenol A;
(meth)acrylates having three or more double bonds, such as glycerol tri(meth)acrylate, trimethylolpropane tri(meth)acrylate, pentaerythritol tetra(meth)acrylate and dipentaerythritol penta(meth)acrylate; glycerol carbonate methacrylate,
2-carbamoyloxyethyl methacrylate.

The monomers A comprising ester groups further include vinyl esters, such as vinyl acetate, vinyl chloride, vinyl Versatate, ethylene-vinyl acetate, ethylene-vinyl chloride;

maleic acid derivatives, such as, for example, maleic anhydride, esters of maleic acid, for example dimethyl maleate, methylmaleic anhydride; and
fumaric acid derivatives, such as dimethyl fumarate.

A further preferred group of comonomers are styrenic monomers, such as, for example, styrene, substituted styrenes having an alkyl substituent in the side chain, such as α-methylstyrene and α-ethylstyrene, substituted styrenes having an alkyl substituent on the ring, such as vinyltoluene and p-methylstyrene and halogenated styrenes, such as monochlorostyrenes, dichlorostyrenes, tribromostyrenes and tetrabromostyrenes, for example.

In addition to the monomers set out above it is possible for polymers of the invention that are obtained by the addition polymerization of monomer mixtures to contain further monomers. These include, for example, heterocyclic vinyl compounds, such as 2-vinylpyridine, 3-vinylpyridine, 2-methyl-5-vinylpyridine, 3-ethyl-4-vinylpyridine, 2,3-dimethyl-5-vinylpyridine, vinylpyrimidine, vinylpiperidine, 9-vinylcarbazole, 3-vinylcarbazole, 4-vinylcarbazole, 1-vinylimidazole, 2-methyl-1-vinylimidazole, N-vinyl-pyrrolidone, 2-vinylpyrrolidone, N-vinylpyrrolidine, 3-vinylpyrrolidine, N-vinylcaprolactam, N-vinylbutyro-lactam, vinyloxolane, vinylfuran, vinylthiophene, vinylthiolane, vinylthiazoles and hydrogenated vinylthiazoles, vinyloxazoles and hydrogenated vinyloxazoles;
1-[2-[[2-hydroxy-3-(2-propenyloxy)propyl]amino]ethyl]-2-imidazolidinone;
1-[2-[[2-hydroxy-3-(2-propen-1-yloxy)propoxy]ethyl]-2-imidazolidinone,
2-methyl-N-[2-(2-oxo-1-imidazolidinyl)ethyl]-2-propenamide,
2-methyl-2-(2-oxo-1-imidazolidinyl)ethyl]-2-propene ester,
trimethylolpropaneoxetane,
1-(butylamino)-3-(2-propen-1-yloxy)-2-propanol;
   maleimide, methylmaleimide;
   vinyl ethers and isoprenyl ethers; and
   vinyl halides, such as vinyl chloride, vinyl fluoride, vinylidene chloride and vinylidene fluoride, for example.

In accordance with the first embodiment, particular preference is given to monomer mixtures which contain 30% to 99% by weight of alkyl acrylate having 1 to 10 carbon atoms in the alkyl radical, whose alkyl radical contains no double bonds or heteroatoms,

0.1% to 10% by weight of (meth)acrylate having at least one aldehyde group in the alkyl radical,
0.1% to 10% by weight of (meth)acrylic monomer having an amino group or amide group,
0% to 60% by weight of alkyl methacrylate having 1 to 10 carbon atoms in the alkyl radical and
0% to 10% by weight of polyalkylene glycol mono(meth)acrylate, based in each case on the weight of the monomers.

Furthermore, particular preference is given to monomer mixtures in accordance with the first embodiment which contain

30% to 99% by weight of alkyl acrylate having 1 to 10 carbon atoms in the alkyl radical, whose alkyl radical contains no double bonds or heteroatoms,
1% to 8% by weight of (meth)acrylate having at least one aldehyde group in the alkyl radical,
1% to 5% by weight of (meth)acrylic monomer having an amino group or amide group,
10% to 45% by weight of alkyl methacrylate having 1 to 10 carbon atoms in the alkyl radical and
1% to 5% by weight of polyalkylene glycol mono(meth)acrylate, based in each case on the weight of the monomers.

In accordance with the second embodiment, particular preference is given to monomer mixtures which contain

30% to 99% by weight of alkyl methacrylate having 1 to carbon atoms in the alkyl radical, whose alkyl radical contains no double bonds or heteroatoms,
0.1% to 10% by weight of (meth)acrylate having at least one aldehyde group in the alkyl radical,
0.1% to 10% by weight of (meth)acrylic monomer having an amino group or amide group,
0% to 60% by weight of alkyl acrylates having 1 to 10 carbon atoms in the alkyl radical and
0% to 10% by weight of polyalkylene glycol mono(meth)acrylate, based in each case on the weight of the monomers.

Furthermore, particular preference is given to monomer mixtures in accordance with the second embodiment which contain

30% to 99% by weight of alkyl methacrylate having 1 to carbon atoms in the alkyl radical, whose alkyl radical contains no double bonds or heteroatoms,
1% to 8% by weight of (meth)acrylate having at least one aldehyde group in the alkyl radical,
1% to 5% by weight of (meth)acrylic monomer having an amino group or amide group,
10% to 50% by weight of alkyl acrylates having 1 to 10 carbon atoms in the alkyl radical and
1% to 5% by weight of polyalkylene glycol mono(meth)acrylate, based in each case on the weight of the monomers.

Preference is given, furthermore, to monomer mixtures which contain a very small fraction of (meth)acrylates having two or more carbon-carbon double bonds which have a reactivity identical with that of a (meth)acrylate group. In one particular modification of the present invention, the fraction of compounds having two or more (meth)acrylate groups is limited preferably to not more than 5% by weight, more particularly to not more than 2% by weight, with particular preference to not more than 1% by weight, with especial preference to not more than 0.5% by weight, and with very particular preference to not more than 0.1% by weight, based on the total weight of the monomers.

The monomer mixtures of the present invention may be used more particularly for preparing or for modifying polymers. The addition polymerization may take place by any known way. Such ways include more particularly free-radical, cationic or anionic addition polymerization, it also being possible to employ variants of these addition polymerization processes, such as, for example, ATRP (atom transfer radical polymerization), NMP processes (nitroxide mediated polymerization) or RAFT (reversible addition fragmentation chain transfer).

The polymers obtainable by these routes are novel and therefore likewise provided by the present invention. The polymers of the invention comprise at least one unit derived from a (meth)acrylate having at least one aldehyde group in the alkyl radical. As already described, the monomers of the invention may be reacted by free-radical addition polymerization. Accordingly the term “unit” arises from the reaction of a double bond, with two covalent bonds being constructed. Customarily these units are also referred to as repeating units, if there are two or more of these units in a polymer.

The aforementioned monomers and monomer mixtures may be reacted, for example, by solution polymerisations, bulk polymerisations or emulsion polymerisations, it being possible to obtain surprising advantages by means of a free-radical emulsion polymerisation.

Methods of emulsion polymerisation are set out in references including Ullmann's Encyclopedia of Industrial Chemistry, Fifth Edition. For such a polymerisation, generally speaking, an aqueous phase is prepared which as well as water may comprise customary additives, more particularly emulsifiers and protective colloids for stabilizing the emulsion.

This aqueous phase is subsequently admixed with monomers, and polymerisation takes place in the aqueous phase. When preparing homogeneous polymer particles, a monomer mixture may be added batchwise or continuously over a time interval.

The emulsion polymerisation may be implemented for example as a miniemulsion or as a microemulsion, as set out in more detail in Chemistry and Technology of Emulsion Polymerisation, A. M. van Herk (editor), Blackwell Publishing, Oxford 2005 and J. O'Donnell, E. W. Kaler, Macromolecular Rapid Communications 2007, 28(14), 1445-1454. A miniemulsion is usually characterized by the use of costabilizers or swelling agents, and often long-chain alkanes or alkanols are used. The droplet size in the case of miniemulsions is situated preferably in the range from 0.05 to 20 μm. The droplet size in the case of microemulsions is situated preferably in the range below 1 μm, allowing particles to be obtained with a size below 50 nm. In the case of microemulsions use is often made of additional surfactants, examples being hexanol or similar compounds.

The dispersing of the monomer-containing phase in the aqueous phase can take place using known agents. These include, more particularly, mechanical methods and also the application of ultrasound.

In the preparation of homogeneous emulsion polymers it is possible with preference to use a monomer mixture which comprises 0.1% to 20%, more preferably 1% to 10%, more particularly 2% to 6% by weight of (meth)acrylates having at least one aldehyde group in the alkyl radical.

When preparing core-shell polymers it is possible to change the composition of the monomer mixture in steps, with polymerisation preferably taking place, before the composition is changed, to a conversion of at least 80% by weight, more preferably at least 95% by weight, based in each case on the total weight of the monomer mixture used. A core-shell polymer here is an addition polymer which has been prepared by a two-stage or multi-stage emulsion polymerisation, without the core-shell construction having been shown by means, for example, of electron microscopy. The progress of the addition polymerisation reaction in each step can be monitored in a known way, as for example by gravimetry or gas chromatography. The monomer composition for preparing the core comprises preferably 50% to 100% by weight of (meth)acrylates, particular preference being given to the use of a mixture of acrylates and methacrylates. In accordance with one particular aspect of the present invention the weight ratio of acrylates to methacrylates in the core may be greater than or equal to 1, more preferably greater than or equal to 2. Following the preparation of the core, a monomer mixture can preferably be grafted onto it or polymerized onto the core, this mixture comprising 1% to 40%, more preferably 2% to 20%, more particularly 3%-10% by weight of (meth)acrylates having at least one aldehyde group in the alkyl radical.

The emulsion polymerisation is carried out preferably at a temperature in the range from 0 to 120° C., more preferably in the range from 30 to 100° C. In this context, polymerisation temperatures in the range from greater than 60 to less than 90° C., advantageously in the range from greater than 70 to less than 85° C., and preferably in the range from greater than 75 to less than 85° C. have been found to be especially favourable.

The polymerisation is initiated with the initiators that are customary for emulsion polymerisation. Suitable organic initiators are, for example, hydroperoxides, such as tert-butyl hydroperoxide or cumene hydroperoxide. Suitable inorganic initiators are hydrogen peroxide and also the alkali metal salts and the ammonium salts of peroxodisulphuric acid, more particularly ammonium, sodium and potassium peroxodisulphate. Suitable redox initiator systems are, for example, combinations of tertiary amines with peroxides or sodium disulphite, and alkali metal salts and the ammonium salts of peroxodisulphuric acid, more particularly sodium and potassium peroxodisulphate. Further details can be taken from the technical literature, more particularly H. Rauch-Puntigam, Th. Volker, “Acryl- and Methacrylverbindungen”, Springer, Heidelberg, 1967 or Kirk-Othmer, Encyclopedia of Chemical Technology, Vol. 1, pages 386ff., J. Wiley, New York, 1978. In the context of the present invention it is particularly preferred to use organic and/or inorganic initiators.

The stated initiators may be used both individually and in a mixture. They are preferably used in an amount of 0.05% to 3.0% by weight, based on the total weight of the monomers of the respective stage. It is also possible with preference to carry out the polymerisation with a mixture of different polymerisation initiators having different half-lives, in order to keep the flow of free radicals constant over the course of the polymerisation and also at different polymerisation temperatures.

Stabilization of the batch is accomplished preferably by means of emulsifiers and/or protective colloids. The emulsion is preferably stabilized by emulsifiers, in order to obtain a low dispersion viscosity. The total amount of emulsifier is preferably 0.1% to 15%, more particularly 1% to 10% and with particular preference 2% to 5% by weight, based on the total weight of the monomers used. In accordance with one particular aspect of the present invention it is possible to add a portion of the emulsifiers during the polymerisation.

Particularly suitable emulsifiers are anionic or nonionic emulsifiers or mixtures thereof, more particularly
alkyl sulphates, preferably those having 8 to 18 carbon atoms in the alkyl radical, alkyl and alkylaryl ether sulphates having 8 to 18 carbon atoms in the alkyl radical and 1 to 50 ethylene oxide units;
sulphonates, preferably alkylsulphonates having 8 to 18 carbon atoms in the alkyl radical, alkylarylsulphonates having 8 to 18 carbon atoms in the alkyl radical, esters and monoesters of sulphosuccinic acid with monohydric alcohols or alkylphenols having 4 to 15 carbon atoms in the alkyl radical; where appropriate these alcohols or alkylphenols may also have been ethoxylated with 1 to 40 ethylene oxide units;
phosphoric acid partial esters and their alkali metal and ammonium salts, preferably alkyl and alkylaryl phosphates having 8 to 20 carbon atoms in the alkyl or alkylaryl radical and 1 to 5 ethylene oxide units;
alkyl polyglycol ethers, preferably having 8 to 20 carbon atoms in the alkyl radical and 8 to 40 ethylene oxide units;
alkylaryl polyglycol ethers, preferably having 8 to 20 carbon atoms in the alkyl or alkylaryl radical and 8 to 40 ethylene oxide units;
ethylene oxide/propylene oxide copolymers, preferably block copolymers, favourably having 8 to 40 ethylene oxide and/or propylene oxide units.

The particularly preferred anionic emulsifiers include, more particularly, fatty alcohol ether sulphates, diisooctyl sulphosuccinate, lauryl sulphate, C15-paraffinsulphonate, it being possible to use these compounds generally in the form of the alkali metal salt, more particularly the sodium salt. These compounds may be obtained commercially, more particularly, under the commercial designations Disponil® FES 32, Aerosol® OT 75, Texapon® K1296 and Statexan® K1 from the companies Cognis GmbH, Cytec Industries, Inc. and Bayer AG.

Judicious nonionic emulsifiers include tert-octylphenol ethoxylate with 30 ethylene oxide units and fatty alcohol polyethylene glycol ethers which have preferably 8 to 20 carbon atoms in the alkyl radical and 8 to 40 ethylene oxide units. These emulsifiers are available commercially under the commercial designations Triton® X 305 (Fluka), Tergitol® 15-S-7 (Sigma-Aldrich Co.), Marlipal® 1618/25 (Sasol Germany) and Marlipal® O 13/400 (Sasol Germany).

With preference it is possible to use mixtures of anionic emulsifier and nonionic emulsifier. The weight ratio of anionic emulsifier to nonionic emulsifier can judiciously be in the range from 20:1 to 1:20, preferably 2:1 to 1:10 and more preferably 1:1 to 1:5. Mixtures which have proved to be especially appropriate are those comprising a sulphate, more particularly a fatty alcohol ether sulphate, a lauryl sulphate, or a sulphonate, more particularly a diisooctyl sulphosuccinate or a paraffin sulphonate, as anionic emulsifier, and an alkylphenol ethoxylate or a fatty alcohol polyethylene glycol ether having in each case preferably 8 to 20 carbon atoms in the alkyl radical and 8 to 40 ethylene oxide units, as nonionic emulsifier.

Where appropriate the emulsifiers can also be used in a mixture with protective colloids. Suitable protective colloids include partially hydrolysed polyvinyl acetates, polyvinylpyrrolidones, carboxymethyl, methyl, hydroxyethyl and hydroxypropyl cellulose, starches, proteins, poly(meth)acrylic acid, poly(meth)acrylamide, polyvinyl sulphonic acids, melamine-formaldehyde sulphonates, naphthalene-formaldehyde sulphonates, styrene-maleic acid and vinyl ether-maleic acid copolymers. If protective colloids are used they are used preferably in an amount of 0.01% to 1.0% by weight, based on the total amount of the monomers. The protective colloids may be included in the initial charge before the start of the polymerization, or metered in. The initiator may be included in the initial charge or metered in. It is also possible, furthermore, to include a portion of the initiator in the initial charge and to meter in the remainder.

The polymerization is preferably started by heating the batch to the polymerization temperature and initial-charge introduction and/or metering of the initiator, preferably in aqueous solution. In this case it is possible for a portion of the monomers to be included in the initial charge to the reactor and for the remainder to be metered in over a defined time period. In general it is advantageous to polymerize the portion of the monomers that has been included in the initial charge to the reactor, and only then to commence the feed. Alternatively to the initial-charge introduction of a defined quantity of monomer, the feed may be interrupted for a number of minutes after, for example, 1%-5% of the monomers have been metered in. The metered feeds of emulsifier and monomers may be carried out separately or, preferably, as a mixture, more particularly as an emulsion in water.

The emulsion polymerisation may be carried out within a broad pH range. The pH is preferably between 2 and 9. In one particular embodiment the polymerisation is carried out at pH levels between 4 and 8, more particularly between 6 and 8. It is also possible for the dispersion to be adjusted, after the polymerisation, to a pH range which is preferred for the application. For pigmented coating systems the range is generally 8-9 or above.

In order to accelerate a desired self-crosslinking, the pH of the dispersion may be adjusted, furthermore, to a level in the range from 1 to 4, more preferably 1.5 to 3. This can be done preferably shortly before the application of the dispersion. In addition, the dispersion can be admixed with catalysts for the catalysis of self-crosslinking, in which case this ought to take place preferably shortly before the application of the coating materials. These catalysts include, among others, alkali metal carbonates, alkali metal cyanides, sodium acetate, dilute aqueous alkalis and dilute hydrochloric acid.

To improve the durability of the coating materials, and especially for the purpose of preventing premature self-crosslinking, the pH may be set at around the neutral point, i.e., in the range from 6 to 9.

The molecular weight of the polymers is within wide limits initially uncritical. While particularly hard and solvent-resistant coating materials having good mechanical properties are desired, then a very high molecular weight may be useful. Preferred emulsion polymers having a high fraction of polymers which are insoluble in THF may be obtained in the manner set out above. The reaction parameters for obtaining a high molecular weight are known. Thus in that case it is possible in particular to omit the use of molecular weight regulators.

Coating materials which have particularly good and easy processing qualities may also contain polymers having a relatively low molecular weight, the solvent resistance and the hardness of these coatings attaining a relatively high level. Preferably these polymers with particularly good processing properties may have a molecular weight below 1 000 000 g/mol, preferably below 500 000 g/mol and more preferably below 250 000 g/mol. The molecular weight may be determined by means of gel permeation chromatography (GPC) against a PMMA standard.

Polymers, more particularly emulsion polymers, having a low molecular weight can be obtained by the addition of molecular weight regulators to the reaction mixture before or during the polymerisation. For this purpose it is possible to use sulphur-free molecular weight regulators and/or sulphur-containing molecular weight regulators.

The sulphur-free molecular weight regulators, without any intention to impose a restriction, include, for example, dimeric α-methylstyrene (2,4-diphenyl-4-methyl-1-pentene), enol ethers of aliphatic and/or cycloaliphatic aldehydes, terpenes, β-terpinene, terpinolene, 1,4-cyclohexadiene, 1,4-dihydro-naphthalene, 1,4,5,8-tetrahydronaphthalene, 2,5-dihydrofuran, 2,5-dimethylfuran and/or 3,6-dihydro-2H-pyran; dimeric α-methylstyrene is preferred.

As sulphur-containing molecular weight regulators it is possible with preference to use mercapto compounds dialkyl sulphides, dialkyl disulphides and/or diaryl sulphides. The following polymerisation regulators are cited by way of example: di-n-butyl sulphide, di-n-octyl sulphide, diphenyl sulphide, thiodiglycol, ethylthioethanol, diisopropyl disulphide, di-n-butyl disulphide, di-n-hexyl disulphide, diacetyl disulphide, diethanol sulphide, di-tert-butyl trisulphide and dimethyl sulphoxide. Compounds used with preference as molecular weight regulators are mercapto compounds, dialkyl sulphides, dialkyl disulphides and/or diaryl sulphides. Examples of these compounds are ethyl thioglycolate, 2-ethylhexyl thioglycolate, cysteine, 2-mercaptoethanol, 1,3-mercaptopropanol, 3-mercapto-propane-1,2-diol, 1,4-mercaptobutanol, mercaptoacetic acid, 3-mercaptopropionic acid, mercaptosuccinic acid, thioglycerol, thioacetic acid, thiourea and alkyl mercaptans such as n-butyl mercaptan, n-hexyl mercaptan or n-dodecyl mercaptan. Polymerisation regulators used with particular preference are mercapto alcohols and marcaptocarboxylic acids.

The molecular weight regulators are used preferably in amounts of 0.05% to 10%, more preferably 0.1% to 5% by weight, based on the monomers used in the polymerisation. In the polymerisation it is of course also possible to employ mixtures of polymerisation regulators. Furthermore, polymerisations using the molecular weight regulators to reduce the minimum film formation temperature (MFFT) of the polymers obtainable thereby may be employed. In accordance with this preferred embodiment, the fraction of molecular weight regulators may be calculated such that the polymers, or the coating materials of the invention, have a minimum film formation temperature (MFFT) of not more than 60° C., more preferably not more than 50° C. and very preferably not more than 40° C., as can be measured in accordance with DIN ISO 2115. The higher the fraction of molecular weight regulator, the lower the minimum film formation temperature.

One of the ways in which the adjustment of the particle radii can be influenced is via the fraction of emulsifiers. The higher this fraction, more particularly at the beginning of the polymerization, the smaller the particles obtained.

The polymers obtainable in accordance with the process described above, especially the emulsion polymers obtainable with preference, represent further subject matter of the present invention.

Preferably the emulsion polymer is uncrosslinked or crosslinked to such a low degree that the fraction which is soluble in tetrahydrofuran (THF) at 20° C. is more than 60% by weight, based on the weight of the emulsion polymer. In a further, preferred embodiment the emulsion polymer can have a fraction of 2% to 60%, more preferably 10% to 50% and very preferably 20% to 40%, by weight, based on the weight of the emulsion polymer, which is soluble in THF at 20° C. To determine the soluble fraction, a sample of the polymer that has been dried is stored in 200 times the amount of solvent, based on the weight of the sample, at 20° C. for 4 h. The drying here is performed in such a way that as far as possible there is no self-crosslinking. This can be done, for example, by freeze-drying. Following storage, the solution is separated, by filtration for example, from the insoluble fraction. After the solvent has been evaporated the weight of the residue is determined. For example, a 0.5 g sample of an emulsion polymer dried under reduced pressure can be stored in 150 ml of THF for 4 hours.

The particle radius of the emulsion polymers can be within a wide range. Thus, in particular, it is possible to use emulsion polymers having a particle radius in the range from 10 to 500 nm, preferably 10 to 100 nm, more preferably 20 to 60 nm. More particularly, particle radii of below 50 nm may be advantageous for film formation and for the coating properties. The radius of the particles can be determined by means of PCS (Photon Correlation Spectroscopy), the data given relating to the r50 value (50% of the particles are smaller, 50% are larger). This can be done using, for example, a Beckman Coulter N5 Submicron Particle Size Analyzer.

The glass transition temperature of the polymer of the invention is situated preferably in the range from −60° C. to 100° C., with particular preference −30° C. to 70° C., more preferably in the range from −20 to 40° C. and very preferably in the range from 0 to 25° C. The glass transition temperature may be influenced via the nature and the fraction of the monomers used to prepare the polymer. The glass transition temperature, Tg, of the addition polymer may be determined in a known way by means of Differential Scanning calorimetry (DSC), more particularly in accordance with DIN EN ISO 11357. The glass transition temperature may be determined with preference as the centre point of the glass stage of the second heating curve, with a heating rate of 10° C. per minute. Moreover, the glass transition temperature Tg may also be calculated approximately in advance by means of the Fox equation. According to Fox T. G., Bull. Am. Physics Soc. 1, 3, page 123 (1956) it is the case that:

$$\frac{1}{Tg} = \frac{{x}_{1}}{{Tg}_{1}} + \frac{{x}_{2}}{{Tg}_{2}} + … + \frac{{x}_{n}}{{Tg}_{n}}$$

where xₙ represents the mass fraction (% by weight/100) of the monomer n and Tgₙ identifies the glass transition temperature, in kelvins, of the homopolymer of the monomer n. Further useful information can be found by the skilled person in the Polymer Handbook, 2nd Edition, J. Wiley & Sons, New York (1975), which gives Tg values for the most common homopolymers. The polymer here may have one or more different glass transition temperatures. These figures therefore apply to a segment obtainable by polymerizing at least one (meth)acrylate having at least one aldehyde group in the alkyl radical, preferably a monomer mixture of the invention.

For many applications and properties the architecture of the polymer is not critical. The polymers, especially the emulsion polymers, may accordingly represent random copolymers, gradient copolymers, block copolymers and/or graft copolymers. Block copolymers and gradient copolymers can be obtained, for example, by discontinuously altering the monomer composition during chain propagation. In accordance with one preferred aspect of the present invention the emulsion polymer comprises a random copolymer in which the monomer composition over the polymerization is substantially constant. Since, however, the monomers may have different copolymerization parameters, the precise composition may fluctuate over the polymer chain of the polymer.

The polymer may constitute a homogeneous polymer which, for example, in an aqueous dispersion forms particles having a consistent composition. In this case the polymer, which is preferably an emulsion polymer, may be composed of one or more segments obtainable by polymerizing a monomer mixture of the invention.

In accordance with another embodiment the emulsion polymer may constitute a core-shell polymer, which may have one, two, three or more shells. In this case the segment obtainable by polymerizing the monomer mixture of the invention preferably forms the outermost shell of the core-shell polymer. The shell may be connected to the core or to the inner shells via covalent bonds.

Moreover, the shell may also be polymerized onto the core or onto an inner shell. In this embodiment the segment obtainable by ways including polymerizing the monomer mixture of the invention may in many cases be separated and isolated from the core by means of suitable solvents.

The weight ratio of segment obtainable by polymerizing the monomer mixture of the invention to core may be situated preferably in the range from 6:1 to 1:6. Where the glass transition temperature of the core is higher than that of the shell, a ratio of 6:1 to 2:1 is particularly preferred; in the opposite case, the particularly preferred ratio is from 1:1 to 1:5.

The core may be formed preferably of polymers comprising 50% to 100%, preferably 60% to 90%, by weight of units derived from (meth)acrylates. Preference here is given to esters of (meth)acrylic acid whose alcohol residue comprises preferably 1 to 30 carbon atoms, more preferably 1 to 20 carbon atoms and very preferably 1 to 10 carbon atoms. They include, more particularly, (meth)acrylates deriving from saturated alcohols, such as methyl (meth)acrylate, ethyl (meth)acrylate, n-propyl (meth)acrylate, isopropyl (meth)acrylate, n-butyl (meth)acrylate, tert-butyl (meth)acrylate, pentyl (meth)acrylate and hexyl (meth)acrylate.

In accordance with one particular embodiment of the present invention the core can be prepared using a mixture which comprises methacrylates and acrylates. Thus it is possible more particularly to use mixtures of methyl methacrylate and acrylates having 2 to 10, preferably 2 to 8 carbon atoms, such as ethyl acrylate, butyl acrylate, hexyl acrylate and ethylhexyl acrylate. Of particular interest are monomer mixtures for preparing the core or one of the inner shells, if the core-shell polymer contains more than one shell, that contain at least 30%, more preferably at least 50% and very preferably at least 60% by weight of acrylates having 2 to 10 carbon atoms, based on the total weight of the monomers for preparing the core or at least one of the inner shells.

Furthermore, the polymers of the core may comprise the comonomers set out above. In accordance with one preferred modification the core may be crosslinked. This crosslinking may be achieved through the use of monomers having two, three or more free-radically polymerizable double bonds.

The shell of an emulsion polymer of the present invention that is obtainable by polymerizing a monomer mixture of the invention may comprise preferably 2% to 8% by weight of units derived from (meth)acrylates having at least one aldehyde group in the alkyl radical.

In accordance with one particular aspect the core may preferably have a glass transition temperature in the range from −30 to 200° C., more particularly in the range from −20 to 150° C. With particular preference the glass transition temperature is >50° C., more particularly >100° C. The shell of the emulsion polymer of the invention, preferably obtainable by polymerizing the monomer mixture of the invention, may preferably have a glass transition temperature in the range from −60° C. to 100° C., with particular preference −30° C. to 70° C., more preferably in the range from −20 to 40° C. and very preferably in the range from 0 to 25° C. In accordance with one particular aspect of the present invention the glass transition temperature of the core may be greater than the glass transition temperature of the shell. Judiciously the glass transition temperature of the core may be at least 10° C., preferably at least 20° C., above the glass transition temperature of the shell. The glass transition temperature here may be determined in accordance with the methods set out above, preferably by DSC.

The polymers obtainable by polymerizing a monomer mixture of the invention can be isolated. In accordance with one particular embodiment of the present invention, the dispersions obtainable by emulsion polymerisation can be employed, as they are, as coating materials.

Coating materials which comprise the above-specified polymers or compounds which are obtainable by reactions with the above-specified monomer mixtures are likewise provided by the present invention. Coating materials are compositions which are suitable for the coating of substrates. The coating materials of the invention are crosslinkable by crosslinking agents.

Furthermore, preferred coating materials show the tendency of self-crosslinking. Self-crosslinking may be obtained in particular by heat-treating the films at temperatures above 40° C., preferably above 60° C., more preferably above 100° C.

The time for which the films are crosslinked is dependent, for example, on the pH of the film and on the nature and amount of the repeating units carrying aldehyde groups, and on the desired mechanical strength of the coating. Of particular interest more particularly are processes in which self-crosslinking is carried out over a time in the range from 10 seconds to 120 minutes, more preferably in the range from 1 minute to 30 minutes. Crosslinked films frequently feature high solvent resistance and outstanding mechanical properties.

Coating materials or polymers containing units derived from monomers with an amino group or amide group exhibit surprising advantages in terms of chemical resistance and the mechanical properties, more particularly the tensile strength, after heat-treatment of the coatings obtained from these coating materials or polymers. Thus the chemical resistance and the mechanical properties may be improved to an unexpected extent by heat treatment.

In accordance with one preferred embodiment the self-crosslinking may be carried out such that the conversion is preferably at least 5%, more preferably at least 10%, with more particular preference at least 20% and very preferably at least 50%, based on the fraction of aldehyde groups used, in order to obtain an outstanding coating. In this context it may be assumed that in a first step an aldol is formed.

Furthermore, preference is given more particularly to variants in which the self-crosslinking is carried out at an elevated temperature, and so there is elimination of water, leading to formation of double bonds. Surprisingly it is possible by this means to obtain particularly solvent-resistant and mechanically stable coatings.

The durability of the coating materials of the invention can be enhanced in particular by storage at a relatively low temperature.

The coating material preferably materials only small amounts of environmentally hazardous solvents, with aqueous dispersions constituting particularly preferred coating materials. The aqueous dispersions preferably have a solids content in the range from 10% to 70% by weight, more preferably 20% to 60% by weight. The dynamic viscosity of the dispersion is dependent on the solids content and the particle size, and may encompass a wide range. In the case of finely divided dispersions with a high polymer content, it may in certain cases be more than 10 000 mPa·s. Usually expedient is a dynamic viscosity in the range from 10 to 4000 mPa·s, preferably 10 to 1000 mPa·s and very preferably 10 to 500 mPa·s, measured in accordance with DIN EN ISO 2555 at 25° C. (Brookfield).

Furthermore, the aqueous dispersions of the invention may be provided conventionally with additives or with further components in order to adapt the properties of the coating material to specific requirements. These adjuvants include more particularly flow improvers, pigments and dyes.

The coating materials of the invention preferably have a minimum film formation temperature of not more than 50° C., more preferably not more than 35° C. and very preferably not more than 25° C., which can be measured in accordance with DIN ISO 2115.

Advantageously the coating material, preferably an aqueous dispersion, may have an acid number in the range from 0 to 100 mg KOH/g, preferably 1 to 40 mg KOH/g and very preferably in the range from 2 to 10 mg KOH/g. The acid number can be determined in accordance with DIN EN ISO 2114 on the basis of a dispersion, the value being related to the solids content.

The hydroxyl number of a coating material of the invention, more particularly of an aqueous dispersion, may be situated preferably in the range from 0 to 400 mg KOH/g, more preferably 1 to 200 mg KOH/g and very preferably in the range from 3 to 150 mg KOH/g. The hydroxyl number may be determined in accordance with DIN EN ISO 4629 on the basis of a dispersion, the value being related to the solids content.

In addition to the emulsion polymers, the dispersions of the invention may also comprise further constituents.

Crosslinking of the polymers of the invention or coating materials may take place by addition of crosslinking agents. Suitability for this purpose is possessed by nucleophilic compounds which have a multiple functionality. Particularly suitable compounds include diamines, such as 2,2′-(ethylenedioxy)diethyl-amine (Jeffamine® XTJ-504, CAS No. 929-59-9), urea (CAS No. 57-13-6) and urea derivatives, such as ethyleneurea (also called imidazolidinone; CAS No. 120-93-4), diphenylurea (CAS No. 102-07-8), diethylurea (CAS No. 623-76-7) and propyleneurea (also called tetra-2-hydropyrimidinone; CAS No. 1852-17-1), and dihydrazides, such as adipic dihydrazide (ADH), for example.

Particularly preferred crosslinking agents are set out in references including WO 94/25433, filed on 25 Apr. 1994 at the European Patent Office with the application number PCT/EP94/01283, reference being made to this publication for disclosure purposes, and the crosslinking agents disclosed therein being incorporated into this specification.

The fraction of crosslinking agent is not critical per se, the amount of crosslinking agent being calculated preferably on the basis of the polymer. With particular preference the molar ratio of crosslinkable groups present in the polymer to the reactive groups of the crosslinking agent is situated in the range from 10:1 to 1:10, more preferably 4:1 to 1:4 and very preferably in the range from 2:1 to 1:2.

The polymers of the present invention can be used more particularly in coating materials or as an adjuvant. Such materials include, in particular, paints and varnishes, impregnating compositions, adhesives and/or primers. With particular preference the coating materials, more particularly the aqueous dispersions, may serve for coating or impregnating leather and/or textiles, examples being woven fabrics, loop-knitted fabrics or nonwovens. Additionally the dispersions may be used to coat woods, metals and plastics. For instance, coating materials for industrial coatings, and architectural paints, exhibit excellent performance capacities, it being possible for these coating materials to be used, for example, for the coating of furniture or floor coverings.

The coatings obtainable from the coating materials of the invention exhibit high solvent resistance; more particularly, only small fractions are dissolved from the coating by solvents. Preferred coatings exhibit a high resistance more particularly to methyl isobutyl ketone (MIBK). Hence the weight loss after treatment with MIBK amounts preferably to not more than 50% by weight, more preferably not more than 35% by weight, with particular preference not more than 20% by weight and with very particular preference not more than 15% by weight, based on the weight of the coating employed. The absorption of MIBK is preferably not more than 1000% by weight, more preferably not more than 800% by weight, with particular preference not more than 600% by weight and very preferably not more than 500% by weight, based on the weight of the coating employed. These values are measured at a temperature of approximately 25° C. over an exposure time of at least 4 hours, the coating subjected to measurement being a fully dried coating which has been crosslinked.

The coatings obtained from the coating materials of the invention display a high mechanical stability. The pendulum hardness is preferably at least 15 s, more preferably at least 25 s, measured in accordance with DIN ISO 1522.

Coatings of the invention exhibit surprisingly good mechanical properties. Of particular interest more particularly are coatings which exhibit a nominal elongation at break of preferably at least 200%, more preferably at least 300%, as measured in accordance with DIN EN ISO 527 Part 3.

Preference is given, furthermore, to coatings which exhibit a tensile strength, as measured in accordance with DIN EN ISO 527 Part 3, of at least 2 MPa, more preferably at least 4 MPa.

Furthermore, the present invention, surprisingly, provides coatings which with a tensile strength of at least 2 MPa, more preferably at least 4 MPa, exhibit an elongation at break of at least 200%, more preferably at least 300%.

Furthermore, preferred coatings obtainable from the coating materials of the invention are distinguished by a surprisingly high adhesive strength, which can be determined more particularly in accordance with the cross-cut test. Hence it is possible more particularly to obtain a classification of 0-1, more preferably of 0, in accordance with the standard DIN EN ISO 2409.

The purpose of the text below is to illustrate the present invention, using inventive and comparative examples, without any intention that this should constitute any restriction.

### Preparation of 4-oxobutyl methacrylate

A 100 ml Parr autoclave with pressure regulator was fed from a burette, maintained at a constant temperature, with 10 mmol of allyl methacrylate in 25 ml of THF, and this feed was reacted under a pressure of 10 bar with a CO/H₂ gas mixture having a molar ratio of 1:1 in the presence of 0.1 mol % of Rh(acac) (CO)₂ [acac=acetyl-acetonate] and 0.2 mol % of xantphos, based in each case on allyl methacrylate, for a reaction time of 20 hours at a temperature of 65° C. A yield of 90% was obtained, the reaction mixture comprising 4-oxobutyl methacrylate and 2-methyl-3-oxopropyl methacrylate. The ratio of 4-oxobutyl methacrylate to 2-methyl-3-oxopropyl methacrylate was 92:8.

### Preparation of a mixture of methacryloyloxy-2-ethyl-fatty acid amides

A four-necked round-bottomed flask equipped with a Saber stirrer with stirrer sleeve and stirrer motor, nitrogen inlet, liquid-phase thermometer and a distillation bridge was charged with 206.3 g (0.70 mol) of fatty acid methyl ester mixture, 42.8 g (0.70 mol) of ethanolamine and 0.27 g (0.26%) of LiOH. The fatty acid methyl ester mixture comprised 6% by weight of saturated C12 to C16 fatty acid methyl esters, 2.5% by weight of saturated C17 to C20 fatty acid methyl esters, 52% by weight of monounsaturated C18 fatty acid methyl ester, 1.5% by weight of monounsaturated C20 to C24 fatty acid methyl esters, 36% by weight of polyunsaturated C18 fatty acid methyl ester and 2% by weight of polyunsaturated C20 to C24 fatty acid methyl esters.

The reaction mixture was heated to 150° C. Over the course of 2 hours, 19.5 ml of methanol were distilled off. The reaction product obtained contained 86.5% of fatty acid ethanolamides. The resulting reaction mixture was processed further without purification.

After cooling, 1919 g (19.2 mol) of methyl methacrylate, 3.1 g of LiOH and an inhibitor mixture consisting of 500 ppm of hydroquinone monomethyl ether and 500 ppm of phenothiazine were added.

With stirring, the reaction apparatus was flushed with nitrogen for 10 minutes. Thereafter the reaction mixture was heated to boiling. The methyl methacrylate/methanol azeotrope was separated off and then the overhead temperature was raised in steps to 100° C. After the end of the reaction, the reaction mixture was cooled to about 70° C. and filtered.

Excess methyl methacrylate was separated off on a rotary evaporator. 370 g of product were obtained.

### INVENTIVE EXAMPLE 1

### Preparation of a Dispersion for Wood and Metal Coating

BuA-co-MMA-ObMA-MAA=46-51-2-1

First of all, in a 1 l PE beaker, 110.4 g of butyl acrylate (BA), 122.4 g of methyl methacrylate (MMA), 4.8 g of oxobutyl methacrylate (ObMA), 2.4 g of methacrylic acid (MAA), 0.72 g of ammonium peroxodisulphate (APS), 7.2 g of Disponil FES 32 (30% form) and 215.5 g of water were emulsified using an Ultra-Turrax at 4000 rpm for 3 minutes.

A 1 l glass reactor which had a facility for temperature conditioning with a water bath, and was equipped with a paddle stirrer, was charged with 134 g of water and 0.18 g of Disponil FES 32 (30% form), and this initial charge was heated to 80° C. and admixed with 0.18 g of ammonium peroxodisulphate (APS) in solution in 10 g of water. 5 minutes after the addition of the APS, the above-prepared emulsion was metered in over the course of 240 minutes (interval: 3 minutes' feed, 4 minutes' pause, 237 minutes' feed of remainder).

After the end of the feed, stirring was continued at 80° C. for 1 hour. Thereafter the dispersion was cooled to room temperature and filtered off on a VA fabric sieve with a mesh size of 0.09 mm.

The emulsion prepared had a solids content of 40±1%, a pH of 2.2, a viscosity of 13 mPas and an r_{N5} value of 65 nm.

### INVENTIVE EXAMPLE 2

### Preparation of a Dispersion for Wood and Metal Coating

BuA-co-MMA-ObMA-MAA=45-50-4-1

Example 1 was essentially repeated, but using as the feed a monomer mixture comprising about 4% by weight of oxobutyl methacrylate, based on the weight of the monomers. To prepare the monomer mixture used, in a 1 l PE beaker, 105.96 g of butyl acrylate (BA), 117.96 g of methyl methacrylate (MMA), 9.6 g of oxobutyl methacrylate, 2.4 g of methacrylic acid (MAA), 4.92 g of methacryloyloxy-2-ethyl-fatty acid amide mixture, 0.72 g of ammonium peroxodisulphate (APS), 7.2 g of Disponil FES 32 (30% form) and 208.6 g of water were emulsified using an Ultra-Turrax at 4000 rpm for 3 minutes.

The emulsion prepared had a solids content of 40±1%, a pH of 2.3, a viscosity of 13 mPas and an r_{N5} value of 65 nm.

### INVENTIVE EXAMPLE 3

### Preparation of a Dispersion for Wood and Metal Coating

BuA-co-MMA-ObMA-MAA=44-49-6-1

Example 1 was essentially repeated, but using as the feed a monomer mixture comprising about 6% by weight of oxobutyl methacrylate, based on the weight of the monomers. To prepare the monomer mixture used, in a 1 l PE beaker, 105.96 g of butyl acrylate (BA), 117.96 g of methyl methacrylate (MMA), 9.6 g of oxobutyl methacrylate, 2.4 g of methacrylic acid (MAA), 4.92 g of methacryloyloxy-2-ethyl-fatty acid amide mixture, 0.72 g of ammonium peroxodisulphate (APS), 7.2 g of Disponil FES 32 (30% form) and 208.6 g of water were emulsified using an Ultra-Turrax at 4000 rpm for 3 minutes.

The emulsion prepared had a solids content of 40±1%, a pH of 2.3, a viscosity of 14 mPas and an r_{N5} value of 68 nm.

### INVENTIVE EXAMPLES 4 TO 6

### Crosslinking of the Dispersions Obtained in Inventive Examples 1 to 3 with Adipic Dihydrazide

The dispersions obtained in Inventive Examples 1 to 3 were crosslinked equimolarly with adipic dihydrazide (ADH). For this purpose a 15% strength ADH solution was added dropwise to the dispersion with stirring, the mixture was stirred for 2 hours and a film was dried at room temperature.

The properties of the coating material thus obtained were investigated by different methods. On dried films, tests of the solvent resistance, water absorption and hardness were carried out.

The solvent resistance was determined using methyl isobutyl ketone (MIBK), with a sample (A) being swollen with MIBK at room temperature for 4 hours. Thereafter the sample was removed from the solvent, excess solvent was removed, and the weight was taken. Thereafter the sample was dried at around 140° C. for 1 hour (B). The weight difference between A and B is used to calculate the fraction of the sample removed by the solvent. The swelling was calculated on the basis of the weight of the sample B freed from soluble fractions, and is referred to in the remainder of the text as “true swelling”.

In addition a furniture test along the lines of DIN 68861-1 was carried out. The evaluation scale is 1-5, where 5 means no visible change and 1 means area under test greatly changed or destroyed.

The adhesion was determined by the cross-cut test in accordance with DIN ISO 2409.

The results obtained are set out in Table 1. Inventive Example 4 was obtained using a dispersion according to Inventive Example 1, Inventive Example 5 using a dispersion according to Inventive Example 2, and Inventive Example 6 using a dispersion according to Inventive Example 3.

### COMPARATIVE EXAMPLE 1

BuA-co-MMA-AAEMA-MAA=46-51-2-1

For comparison, instead of oxobutyl methacrylate, the commercially available acetoacetoxyethyl methacrylate (AAEMA) was incorporated into dispersions.

Accordingly, Example 1 was essentially repeated, but using as the feed a monomer mixture comprising about 2% by weight of acetoacetoxyethyl methacrylate instead of oxobutyl methacrylate, based on the weight of the monomers. To prepare the monomer mixture used, in a 1 l PE beaker, 110.4 g of butyl acrylate (BA), 122.4 g of methyl methacrylate (MMA), 4.8 g of acetoacetoxyethyl methacrylate (AAEMA), 2.4 g of methacrylic acid (MAA), 0.72 g of ammonium peroxodisulphate (APS), 7.2 g of Disponil FES 32 (30% form) and 215.5 g of water were emulsified using an Ultra-Turrax at 4000 rpm for 3 minutes.

The emulsion prepared had a solids content of 40±1%, a pH of 2.4, a viscosity of 12 mPas and an r_{N5} value of 65 nm.

### COMPARATIVE EXAMPLE 2

BuA-co-MMA-AAEMA-MAA=45-50-4-1

Comparative Example 1 was essentially repeated, but using as the feed a monomer mixture comprising about 4% by weight of acetoacetoxyethyl methacrylate, based on the weight of the monomers. To prepare the monomer mixture used, in a 1 l PE beaker, 108 g of butyl acrylate (BA), 120 g of methyl methacrylate (MMA), 9.6 g of acetoacetoxyethyl methacrylate (AAEMA), 2.4 g of methacrylic acid (MAA), 0.72 g of ammonium peroxodisulphate (APS), 7.2 g of Disponil FES 32 (30% form) and 215.5 g of water were emulsified using an Ultra-Turrax at 4000 rpm for 3 minutes.

The emulsion prepared had a solids content of 40±1%, a pH of 2.4, a viscosity of 14 mPas and an r_{N5} value of 62 nm.

### COMPARATIVE EXAMPLE 3

BuA-co-MMA-AAEMA-MAA=44-49-6-1

Comparative Example 1 was essentially repeated, but using as the feed a monomer mixture comprising about 6% by weight of acetoacetoxyethyl methacrylate, based on the weight of the monomers. To prepare the monomer mixture used, in a 1 l PE beaker, 105.6 g of butyl acrylate (BA), 117.6 g of methyl methacrylate (MMA), 14.4 g of acetoacetoxyethyl methacrylate (AAEMA), 2.4 g of methacrylic acid (MAA), 0.72 g of ammonium peroxodisulphate (APS), 7.2 g of Disponil FES 32 (30% form) and 215.5 g of water were emulsified using an Ultra-Turrax at 4000 rpm for 3 minutes.

The emulsion prepared had a solids content of 40±1%, a pH of 2.4, a viscosity of 13 mPas and an r_{N5} value of 61 nm.

### COMPARATIVE EXAMPLES 4 TO 6

### Crosslinking of the Dispersions Obtained in Comparative Examples 1 to 3 with Dihydrazide

The dispersions obtained in Comparative Examples 1 to 3 were crosslinked equimolarly with adipic dihydrazide (ADH). For this purpose a 15% strength ADH solution was added dropwise to the dispersion with stirring, the mixture was stirred and a film was dried at room temperature.

The properties of the coating material thus obtained were investigated by different methods. On dried films, tests of the solvent resistance, adhesion and hardness were carried out, as set out above in connection with Inventive Examples 4 to 6.

Comparative Example 4 was obtained using a dispersion according to Comparative Example 1, Comparative Example 5 using a dispersion according to Comparative Example 2, and Comparative Example 6 using a dispersion according to Comparative Example 3.

The results obtained are set out in Table 1.

TABLE 1
Results of the property investigations

| | Inventive | Inventive | Inventive |
|---|---|---|---|
| | Example 4 | Example 5 | Example 6 |
| Pendulum hardness [s] | 68.6 | 93.8 | 120.4 |
| after 1 week | | | |
| True swelling in MIBK [%] | 981 | 715 | 480 |
| Weight loss in MIBK [%] | 16.7 | 14.0 | 5.9 |
| Cross-cut to ISO 2409 | 0/0 | 0/0 | 0/0 |
| without/with tesa tape | | | |
| Furniture test ethanol | 5/5 | 5/5 | 5/5 |
| after 1 h/16 h | | | |
| Furniture test HOAc after | 5/5 | 5/5 | 5/5 |
| 1 h/16 h | | | |
| Furniture test NH3 after | 4/4 | 4/4 | 5/5 |
| 1 h/16 h | | | |
| Furniture test Nivea | 5/5 | 5/5 | 5/5 |
| after 1 h/16 h | | | |
| | Comparative | Comparative | Comparative |
| | Example 4 | Example 5 | Example 6 |
| Pendulum hardness [s] | 60.2 | 77.0 | 86.8 |
| after 1 week | | | |
| True swelling in MIBK | 1014 | 955 | 607 |
| [%] | | | |
| Weight loss in MIBK | 20.8 | 17.4 | 8.3 |
| [%] | | | |
| Cross-cut to ISO 2409 | 0/0 | 0/0 | 0/0 |
| Furniture test | 5/5 | 5/5 | 5/5 |
| ethanol after 1 h/16 h | | | |
| Furniture test HOAc | 5/5 | 5/5 | 5/5 |
| after 1 h/16 h | | | |
| Furniture test NH3 | 4/3 | 4/4 | 4/4 |
| after 1 h/16 h | | | |
| Furniture test Nivea | 5/5 | 5/5 | 5/5 |
| after 1 h/16 h | | | |

The dispersions obtained in accordance with Inventive Examples 4 to 6 exhibit an outstanding spectrum of properties in the context of a coating material for wood and metal.

### INVENTIVE EXAMPLE 7

Inventive Example 2 was essentially repeated, but using as the feed a monomer mixture comprising 1.7% by weight of methacrylamide, based on the weight of the monomers. To prepare the monomer mixture used, in a 1 l PE beaker, 105.96 g of butyl acrylate (BA), 117.96 g of methyl methacrylate (MMA), 9.6 g of oxobutyl methacrylate, 2.4 g of methacrylic acid (MAA), 4.08 g of methacrylamide (MAcA), 0.72 g of ammonium peroxodisulphate (APS), 7.2 g of Disponil FES 32 (30% form) and 208.6 g of water were emulsified using an Ultra-Turrax at 4000 rpm for 3 minutes.

The emulsion prepared had a solids content of 40±1%, a viscosity of 12 mPas and an r_{N5} value of 66 nm.

### INVENTIVE EXAMPLE 8

Inventive Example 2 was essentially repeated, but using as the feed a monomer mixture comprising about 2% by weight of methacryloyloxy-2-ethyl-fatty acid amide mixture, based on the weight of the monomers. To prepare the monomer mixture used, in a 1 l PE beaker, 105.96 g of butyl acrylate (BA), 117.96 g of methyl methacrylate (MMA), 9.6 g of oxobutyl methacrylate, 2.4 g of methacrylic acid (MAA), 4.92 g of methacryloyloxy-2-ethyl-fatty acid amide mixture, 0.72 g of ammonium peroxodisulphate (APS), 7.2 g of Disponil FES 32 (30% form) and 208.6 g of water were emulsified using an Ultra-Turrax at 4000 rpm for 3 minutes.

The emulsion prepared had a solids content of 39±1%, a viscosity of 11 mPas and an r_{N5} value of 65 nm.

### INVENTIVE EXAMPLES 9 TO 11

The emulsions of Inventive Examples 2, 7 and 9 were subjected to self-crosslinking. For this purpose the pH of all of the dispersions was adjusted to a value of 5.8. From the dispersions, coatings were produced, and their swelling in MIBK was investigated. In this case a film was produced at room temperature and was dried at that temperature for 24 hours.

The solvent resistance was determined using methyl isobutyl ketone (MIBK), with a sample being swollen with MIBK at room temperature for 4 hours. Thereafter the sample was removed from the solvent, and excess solvent was removed. The solvent absorption was calculated from the weight of the swollen sample. Subsequently the sample was dried at around 140° C. for 1 hour. The weight loss is used to calculate the fraction of the sample removed by the solvent.

The results obtained are set out in Table 2. Inventive Example 9 was obtained using a dispersion according to Inventive Example 2, Inventive Example 10 using a dispersion according to Inventive Example 7, and Inventive Example 11 using a dispersion according to Inventive Example 8.

TABLE 2

| | Solvent | Weight loss | True |
|---|---|---|---|
| | absorption | after re- | swelling |
| | [%] | drying [%] | [%] |
| Inventive Example 9 | 992 | 24.1 | 1307 |
| Inventive Example 10 | 565 | 11.4 | 637 |
| Inventive Example 11 | 814 | 17.9 | 991 |

### INVENTIVE EXAMPLE 12

### Preparation of a Dispersion for Textile Applications on the Following Basis: BA-co-MMA-oxobutyl methacrylate-HEMA)

First of all, in a 2 l PE beaker, 210.4 g of butyl acrylate (BA), 167.6 g of methyl methacrylate (MMA), 12 g of oxobutyl methacrylate (ObMA), 10 g of 2-hydroxyethyl methacrylate (HEMA), 12 g of 4,4′-azobis(4-cyanovaleric acid), 12 g of Disponil FES 32 (30% form) and 345.68 g of water were emulsified using an Ultra-Turrax at 4000 rpm for 3 minutes.

A 2 l glass reactor which had a facility for temperature conditioning with a water bath, and was equipped with a paddle stirrer, was charged with 240 g of water and 0.3 g of Disponil FES 32 (30% form), and this initial charge was heated to 80° C. and admixed with 3 g of 4,4′-azobis(4-cyanovaleric acid). 5 minutes after the addition of the initiator, the above-prepared emulsion was metered in over the course of 240 minutes (interval: 3 minutes' feed, 4 minutes' pause, 237 minutes' feed of remainder). The emulsion was metered from a feed vessel, using a Lewa piston-type metering pump, model HK, with a 5 mm piston, set to an output of 0.193 kg/h.

After the end of the feed, stirring was continued at 80° C. for 1 hour. Thereafter the dispersion was cooled to room temperature and filtered off on a VA fabric sieve with a mesh size of 0.09 mm.

The emulsion prepared had a solids content of 40±1%, a pH of 6.4, a viscosity of 11 mPas and an r_{N5} value of 107 nm.

This was followed by a pH adjustment with phosphoric acid to pH ˜2.0.

### INVENTIVE EXAMPLE 13

### Preparation of a Dispersion for Textile Applications on the Following Basis: BA-co-MMA-oxobutyl methacrylate-MAcA)

Inventive Example 12 was essentially repeated. However, the feed used was a monomer mixture comprising methacrylamide. This monomer mixture was prepared by emulsifying, in a 2 l PE beaker, 212 g of butyl acrylate (BA), 169.2 g of methyl methacrylate (MMA), 12 g of oxobutyl methacrylate (ObMA), 6.8 g of methacrylamide (MAcA), 12 g of 4,4′-azobis(4-cyanovaleric acid), 12 g of Disponil FES 32 (30% form) and 345.68 g of water using an Ultra-Turrax at 4000 rpm for 3 minutes.

The emulsion prepared had a solids content of 40±1%, a pH of 6.3, a viscosity of 12 mPas and an r_{N5} value of 93 nm. Subsequently the pH was adjusted with phosphoric acid to pH ˜2.0.

The dispersions set out in Inventive Examples 12 and 13 were used to produce coatings, whose mechanical properties and swelling in a solvent (MIBK) were investigated. In this case a film was produced at room temperature and was dried at that temperature for 24 hours. A further film was produced at room temperature, but additionally heated at 140° C. for 30 minutes. The results are summarized in Tables 3 to 6.

TABLE 3
Swelling tests in MIBK (4 h); film production
at RT

| | Solvent | Weight loss | True |
|---|---|---|---|
| | absorption | after re- | swelling |
| | [%] | drying [%] | [%] |
| Inventive Example 12 | 449 | 13.1 | 532 |
| Inventive Example 13 | 355 | 9.1 | 400 |

TABLE 4
Swelling tests in MIBK (4 h); film heated at
140° C. for 30 min

| | Solvent | Weight loss | True |
|---|---|---|---|
| | absorption | after re- | swelling |
| | [%] | drying [%] | [%] |
| Inventive Example 12 | 350 | 5.9 | 378 |
| Inventive Example 13 | 287 | 4.8 | 307 |

TABLE 5
Mechanical properties of the films; film
production at RT

| | (nom.) Elongation | Tensile |
|---|---|---|
| | at break | strength |
| | [%] | [MPa] |
| Inventive Example 12 | 410.5 | 8.3 |
| Inventive Example 13 | 327.4 | 8 |

TABLE 6
Mechanical properties of the films; film
heated at 140° C. for 30 min.

| | (Nom.) elongation | Tensile |
|---|---|---|
| | at break | strength |
| | [%] | [MPa] |
| Inventive Example 12 | 350.1 | 5.5 |
| Inventive Example 13 | 329.4 | 11.1 |

1. A monomer mixture comprising:
at least 30% by weight of (A) at least one alkyl (meth)acrylate having 1 to 10 carbon atoms in the alkyl radical, whose alkyl radical comprises no double bonds or heteroatoms; and
0.1% to 40% by weight of (B) at least one (meth)acrylate comprising at least one aldehyde group in the alkyl radical,
wherein the at least one (meth)acrylate comprising at least one aldehyde group in the alkyl radical further comprises a hydrogen atom on the carbon atom in alpha-position to the aldehyde group.

2. The monomer mixture according to claim 1, wherein the at least one (meth)acrylate (B) comprising at least one aldehyde group in the alkyl radical comprises 3 to 9 carbon atoms in the alkyl radical.

3. The monomer mixture according to claim 1, further comprising:
(C) at least one (meth)acrylic monomer comprising an amino group or amide group.

4. The monomer mixture according to claim 3, wherein the (meth)acrylic monomer (C) comprises a primary or tertiary amino group.

5. The monomer mixture according to claim 3, comprising 0.1% to 10% by weight of the at least one (meth)acrylic monomer (C) having an amino group or amide group.

6. The monomer mixture according to claim 1, further comprising:
(D) at least one polyalkylene glycol mono(meth)acrylate.

7. The monomer mixture according to claim 6, wherein the at least one polyalkylene glycol mono(meth)acrylate (D) has a weight-average molecular weight in a range from 350 to 20 000 g/mol.

8. The monomer mixture according to claim 6, wherein the at least one polyalkylene glycol mono(meth)acrylate (D) is a methoxypolyethylene glycol monomethacrylate.

9. The monomer mixture according to claim 1, comprising:
at least 30% by weight of at least one alkyl acrylate having 1 to 10 carbon atoms, whose alkyl radical comprises no double bonds or heteroatoms.

10. The monomer mixture according to claim 9, wherein the at least one alkyl acrylate comprising 1 to 10 carbon atoms in the alkyl radical is selected from the group consisting of ethyl acrylate, butyl acrylate, and ethylhexyl acrylate.

11. The monomer mixture according to claim 1, comprising:
at least 30% by weight of at least one alkyl methacrylate having 1 to 10 carbon atoms, whose alkyl radical comprises no double bonds or heteroatoms.

12. The monomer mixture according to claim 11, wherein the at least one alkyl methacrylate is selected from the group consisting of methyl methacrylate and a cycloalkyl methacrylate.

13. The monomer mixture according to claim 1, comprising:
at least one alkyl acrylate having 1 to 10 carbon atoms in the alkyl radical, whose alkyl radical comprises no double bonds or heteroatoms; and
at least one alkyl methacrylate having 1 to 10 carbon atoms in the alkyl radical, whose alkyl radical comprises no double bonds or heteroatoms,
wherein a weight ratio of the at least one alkyl acrylate having 1 to 10 carbon atoms in the alkyl radical to the at least one alkyl methacrylate having 1 to 10 carbon atoms in the alkyl radical is in a range from 1:1 to 50:1.

14. The monomer mixture according to claim 1, comprising:
at least one alkyl acrylate having 1 to 10 carbon atoms in the alkyl radical, whose alkyl radical contains comprises no double bonds or heteroatoms; and
at least one alkyl methacrylate having 1 to 10 carbon atoms in the alkyl radical, whose alkyl radical comprises no double bonds or heteroatoms,
wherein a weight ratio of the at least one alkyl acrylate having 1 to 10 carbon atoms in the alkyl radical to the at least one alkyl methacrylate having 1 to 10 carbon atoms in the alkyl radical is in a range from 1:50 to 1:1.

15. A polymer, comprising repeating units derived from the monomer mixture according to claim 1.

16. The polymer according to claim 15, in the form of an emulsion polymer.

17. The polymer according to claim 15, in the form of a core-shell polymer, comprising a core and a shell.

18. The polymer according to claim 17, the core of the core-shell polymer comprises at least 50% to 100% by weight of at least one (meth)acrylate.

19. A coating material, comprising the polymer according to claim 15.

20. A method of producing a coating, the method comprising:
(A) applying the coating material according to claim 19 to a substrate, to give a coated substrate; and
(B) curing the coated substrate, to give a cured coated substrate comprising the coating.

21. The method according to claim 20, the coating material is applied, in the applying (A), to at least one selected from the group consisting of a wood, a metal, a plastic, a textile, a nonwoven, and a leather.

22. The method according to claim 20, wherein the polymer is reacted with a diamine and/or a dihydrazide.

23. The method according to claim 20, wherein the polymer is subjected to self-crosslinking by heat treatment at a temperature above 40° C.

24. A coated article, obtained by the method according to claim 20.

25. The monomer mixture according to claim 1, wherein the at least one (meth)acrylate (B) comprising at least one aldehyde group in the alkyl radical is 4-oxobutyl (meth)acrylate or 2-methyl-3-oxopropyl (meth)acrylate.
